(19) United States
(12) Patent Application Publication
(10) Pub. No.: US 2016/0269631 A1
(43) Pub. Date: Sep. 15, 2016

(54) IMAGE GENERATION METHOD, SYSTEM, AND APPARATUS

(71) Applicant: FUJITSU LIMITED, Kawasaki-shi (JP)

(72) Inventors: SHAN JIANG, Zama (JP); Keiju Okabayashi, Sagamihara (JP); Riichiro Take, Setagaya (JP)

(73) Assignee: FUJITSU LIMITED, Kawasaki-shi (JP)

(21) Appl. No.: 15/062,408

(22) Filed: Mar. 7, 2016

(30) Foreign Application Priority Data
Mar. 9, 2015 (JP) 2015-046130

(51) Int. Cl. H04N 5/232; H04N 5/265; G09B 5/02; G06T 7/00

(52) U.S. Cl. CPC H04N 5/23238; G06T 7/004; H04N 5/265; G09B 5/02; G06T 2207/10016; G06T 2207/30244

(57) ABSTRACT

An image generation method is disclosed. A first image including an object placed in a real space is captured by using an imaging device. A first posture of the imaging device is detected when the first image is captured by the imaging device. A second image including the object placed in the real space is captured by the imaging device. A second posture of the imaging device is detected when the second image is captured. A relative location relationship between a first object location included in the first image and a second object location included in the second image are calculated based on the first posture and the second posture. A third image is generated by merging the first image and the second image based on the calculated relative location relationship.

### CROSS-REFERENCE TO RELATED APPLICATIONS

This application is based upon and claims the benefit of priority of the prior Japanese Patent Application No. 2015-046130, filed on Mar. 9, 2015, the entire contents of which are incorporated herein by reference.

### FIELD

The embodiments discussed herein are related to an image generation technology.

### BACKGROUND

Technologies have been known in which instruction information made on an image, which is transmitted from a small camera mounted on an operator in a remote place, is overlaid with the image and the image where the instruction information is overlaid is displayed at a Head-Mounted Display (HMD) worn by the operator.

A technology has been proposed to overlay and display, in a display area where a displacement due to a different eye location for each operator is adjusted, an index pointing towards a region to be operated on at a target location in an actual optical image. Another technology has been presented to display a still image including an operational subject at a display section which is mounted on the operator when it is determined that an operational subject is out of view.
Patent Document 1: Japanese Laid-open Patent Publication No. 2008-124795;
Patent Document 2: Japanese Laid-open Patent Publication No. 2012-182701;
Non-Patent Document 1: Hideaki Kuzuoka et al., “GestureCam: A video communication system for sympathetic remote collaboration”, 1994;
Non-Patent Document 2: Takeshi Kurata et al., “VizWear:Human-Centered Interaction through Computer Vision and Wearable Display”, 2001; and
Non-Patent Document 3: Hirokazu Kato et al., “An Augmented Reality System and its Calibration based on Marker Tracking”, 1999.

### SUMMARY

According to one aspect of the embodiments, there is provided image generation method including capturing a first image including an object placed in a real space by using an imaging device; detecting a first posture of the imaging device when the first image is captured; capturing, by the imaging device, a second image including the object placed in the real space; detecting, by a computer, a second posture of the imaging device when the second image is captured; calculating, by the computer, a relative location relationship between a first object location included in the first image and a second object location included in the second image based on the first posture and the second posture; and generating, by the computer, a third image by merging the first image and the second image based on the relative location relationship being calculated.

As an other aspect of the embodiments, there may be provided an apparatus, a program, and a non-transitory or tangible computer-readable recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of a remote operation support;

FIG. 2 is a diagram illustrating an example of a work flow;

FIG. 3 is a diagram for explaining an operation supporting method in a first embodiment;

FIG. 4 is a diagram illustrating a hardware configuration of a system;

FIG. 5 is a diagram illustrating a functional configuration in the first embodiment;

FIG. 6 is a diagram illustrating a part of the functional configuration depicted in FIG. 5;

FIG. 7 is a diagram illustrating details of the functional configuration depicted in FIG. 6;

FIG. 8A and FIG. 8B are diagrams illustrating the principle of panorama image generation;

FIG. 9A and FIG. 9B are diagrams for explaining a panorama image generation process;

FIG. 10 is a diagram illustrating an example of a marker visible range;

FIG. 11A and FIG. 11B are flowcharts for explaining a display process of the panorama image in the system;

FIG. 12 is a diagram for explaining a coordinate conversion;

FIG. 13 is a diagram illustrating a configuration for acquiring information of a location and a posture by using an IMU;

FIG. 14 is a diagram illustrating a configuration example of an integration filter;

FIG. 15 is a diagram for explaining a projection onto a cylinder;

FIG. 16 is a diagram for explaining a projection on to a sphere;

FIG. 17 is a diagram for explaining a feature point map;

FIG. 18A and FIG. 18B are diagrams for explaining a display method of the panorama image based on the movement of the head of the operator;

FIG. 19A, FIG. 19B, and FIG. 19C are diagrams for explaining speed-up of a panorama image generation process;

FIG. 20A and FIG. 20B are diagram illustrating an example of the panorama image depending on a movement of right and left;

FIG. 21 is a diagram for explaining a presentation method of an instructor;

FIG. 22A, FIG. 22B, and FIG. 22C are diagrams for explaining a method for guiding an operator to an instruction target;

FIG. 23 is a diagram illustrating a functional configuration in a second embodiment;

FIG. 24 is a diagram illustrating a functional configuration of a place server;

FIG. 25A and FIG. 25B are diagrams illustrating the panorama image in the first and second embodiments; and

FIG. 26A, FIG. 26B, and FIG. 26C are diagrams illustrating image examples at a time T2 after a time T1.

### DESCRIPTION OF EMBODIMENTS

In the above described technologies, an image transmitted from an operator is limited to a visual range. In addition, the image tends to swing up and down and side to side depending on a movement of a head of the operator. Hence, it may be difficult for an instructor who sends an instruction to the operator to capture a full picture at a work site. In order for the instructor to conduct more appropriate instruction, it is preferable to provide the full picture of the work site at real time.

In the following, a technology will be presented to generate a panorama image by using a moving device at high speed.

Preferred embodiments of the present invention will be described with reference to the accompanying drawings. Currently, at the work site, there are problems such as labor shortage, training of field engineers, and the like. In order to increase work productivity, it is desired to realize a system for the operator to cooperatively accomplish the operation remotely with the instructor in a state in which the instructor, a person of experience such as a specialist, or the like accurately comprehends a visual scene of a remote place, and takes an interaction with an unskilled operator such as a new operator as intended.

Recently, a smart device, a wearable technology, and a wireless communication technology have been developed, and a remote operation supporting system has been gaining attention. For instance, a head mounted display (HMD) and a head mounted camera (HMC) are connected to the smart device. The operator at the work site and the instructor at the remote place, who cooperate with each other, are connected by a wireless network. Information of a circumstance of an actual working space at the work site is transmitted by video and audio. Also, an instruction from the instructor is displayed by a visual annotation at the HMD.

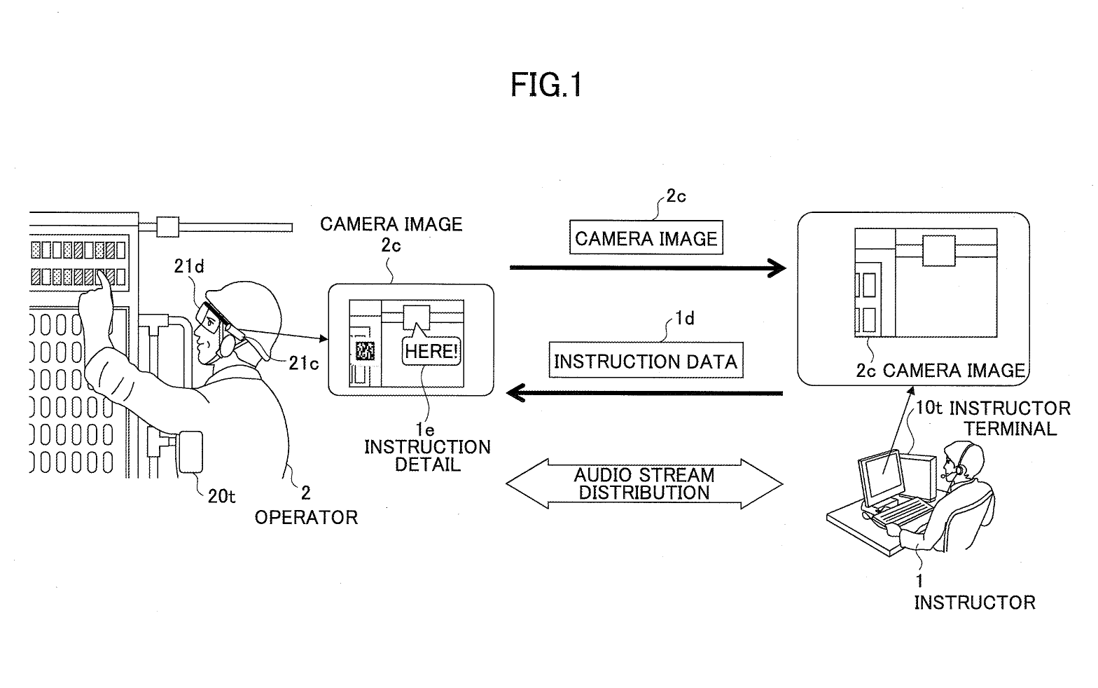

FIG. 1 is a diagram for explaining an example of a remote operation support. In FIG. 1, an operator 2 at the work site puts on an operator terminal 20t, a display device 21d, and a camera 21c, and reports a circumstance at the work site. An instructor 1 manipulates an instructor terminal 10t, and sends an instruction to the operator 2.

The operator terminal 20t is an information processing terminal such as a smart device, and includes a communication function and the like. The wearable HMD capable of inputting and outputting an audio sound is preferable as the display device 21d.

The HMC being a wearable small camera such as a Charge Coupled Device (CCD) is preferable as the camera 21c.

The display device 21d and the camera 21c are mounted on the head of the operator 2, and communicate with the operator terminal 20t by a short distance radio communicating part or the like.

At the work site, the camera 21c of the operator 2 captures a camera image 2c presenting an environment of a work site, and the camera image 2c is transmitted from the operator terminal 20t to the instructor terminal 10t. The camera image 2c is displayed at the instructor terminal 10t.

When the instructor 1 inputs an instruction detail 1e on the camera image 2c displayed at the instructor terminal 10t, instruction data 1d is sent to the operator terminal 20t. When the operator terminal 20t receives the instruction data 1d, an image generated by integrating the camera image 2c and the instruction detail 1e is displayed at the display device 21d.

Also, the operator 2 and the instructor 1 may communicate with each other, and an audio stream is distributed between the operator terminal 20t and the instructor 10t.

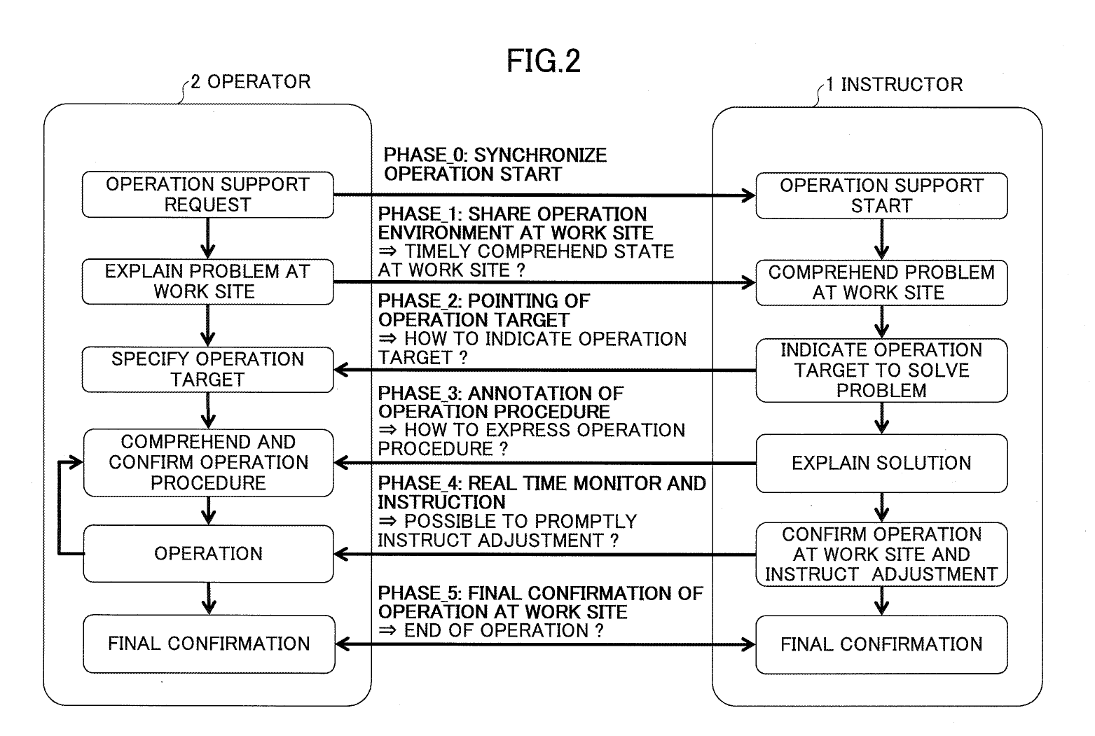

A work flow of remote working support will be described with reference to FIG. 2. FIG. 2 is a diagram illustrating an example of the work flow. In FIG. 2, first, when the operator 2 requests operation support from the instructor 1, the instructor 1 begins the operation support. The operator 2 and the instructor 1 synchronize a start of an operation (PHASE_0). That is, the instructor 1 starts to receive the camera image 2c and the like of the work site. The instructor 1 becomes ready to support the operator 2.

When the operation support begins, a problem at the work site is explained by the operator 2 (PHASE_1). Based on the explanation of the operator 2 and the camera image 2c at the work site, the instructor 1 comprehends the problem of the work site. In the PHASE_1, it is preferable to accurately and promptly transmit the circumstance at the work site to the instructor 1.

When the circumstance of the work site, that is, the environment of the working place is shared between the operator 2 and the instructor 1, the instructor 1 indicates an operation target at the work site to solve the problem with respect to the camera image 2c displayed at the instructor terminal 10t (PHASE_2). In the PHASE_2, it is preferable to accurately point out the operation target in a location relationship with the operator 2.

After the operation target is specified at the display device 21d of the operator 2, the instructor 1 may explain how to solve the problem, and the operator 2 comprehends and confirms an operation procedure (PHASE_3). The explanation of solving the problem is performed by displaying the instruction detail 1e and voice communication by the audio stream. In the PHASE_3, it is preferable to accurately present the operation procedure to the operator 2 in order for the operator 2 to easily comprehend the operation procedure.

When the operator 2 easily comprehends and confirms the operation procedure, the operator 2 performs an operation at the work site. While the operator 2 is working, the instructor 1 views the camera image 2c and the like transmitted from the operator terminal 20t, confirms the work site, and instructs making an adjustment of the operation if necessary (PHASE_4). In the PHASE_4, it is preferable that an instruction to adjust the operation is immediately conveyed to the operator 2 without delay, so that the operator 2 accurately notified.

When the operator 2 ends the operation, an end of the operation at the work site is confirmed between the operator 2 and the instructor 1 (PHASE_5). A final confirmation is made by the operator 2 and the instructor 1. Then, the operation at the work site is completed.

The PHASE_1 and PHASE_2 are considered. By referring to the Non-Patent Document 1, a camera at a side of the instructor 1 captures demonstration the instructor 1 pointing at the operation target with respect to the camera image 2c displayed at a display part. Then, the display device 21d mounted on the head of the operator 2 displays the instructor 1 with the camera image 2c. The same visual field in the PHASE_1 is shared between the operator 2 and the instructor 1, and it is possible for the instructor 1 to see the circumstance in front of the operator 2 at the work site.

However, since the camera image 2c is an image based on a viewpoint of the camera 21c mounted on the head of the operator 2, a range for the instructor 1 to see is dependent on a visual angle of the camera 21c and a direction of the head of the operator 2. Accordingly, it is difficult to comprehend the full picture at the work site.

In the PHASE_2, when the instructor 1 attempts to instruct the operator 2 regarding the camera 21c of the operator 2, the instructor 1 leads the operator 2 to change a direction of the head, and to be stable. Advantageously, the same visual field is shared. However, it is difficult to precisely give the instruction outside of the visual field with respect to the operator 2.

Next, regarding PHASE_2, a case of applying the Non-Patent Document 2 will be considered. Based on the Non-Patent Document 2, information is set beforehand to present to the panorama image of the work site to be referred to. The camera image 21c is received from a wearable computer, a portion corresponding to the camera image 21c currently received from the operator 2 is detected in the panorama image which is prepared beforehand. The information for the detected portion is displayed at the display device 21d of the operator 2.

The panorama image at the work site in the Non-Patent Document 2 may be an image presenting the entirety of the work site, but does not present a current work site. Also, since the information being set beforehand is displayed at the display device 21d of the operator 2, there is no interaction with the instructor 1. In addition, a real time pointing is not realized.

Since the panorama image is prepared beforehand, any change at the work site is not presented in the panorama image. Accordingly, an Augmented Reality (AR) indication from the remote place is not realized.

As described above, it may be possible to send the camera image 2c as a live image from the operator 2 at the work site to the instructor 1. However, there are the following problems:
The range for the instructor 1 to view depends on the visual angle of the camera 21c and the direction of the head of the operator 2. Thus, it is difficult to comprehend the full picture of an actual state at the work site.
Even if the instructor 1 attempts to display instruction information at the display device 21d of the operator 2, the instructor 1 first leads the operator 2 to change the direction of the head and requests the operator 2 to be stable at a desired direction of the instructor 1.
In order to give instruction outside the visual field, the instructor 1 instructs the operator 2 to change the direction of the head to search for an object.
It may be considered to attach the instruction information to the panorama image generated by composing multiple camera images 2c. In this case, if an image to which the instruction information is attached is not transmitted to the operator 2 to display the image, the instructor 2 is not notified of the instruction. Even if the image is displayed at the display device 21d, the operator 2 needs to compare the image transmitted from the instructor 1 with a scene at the work site. Thus, it is not effective and also, communication is time consuming.

In the following embodiments, a reference point is defined at the work site, and the panorama image is created as the reference is a center. With respect to the panorama image created in this manner, when the instructor 1 points out the operation target, relative coordinates from the reference point and the instruction information input by the instructor 1 are provided to the operator terminal 2. Accordingly, it is possible to reduce the communication load.

Also, the instruction information received from the operator terminal 20t is displayed at the display device 21d by overlaying with the current camera image 2c (AR overlay) based on the relative coordinates. That is, a remote instruction is effectively communicated from the instructor 1 to the operator 2.

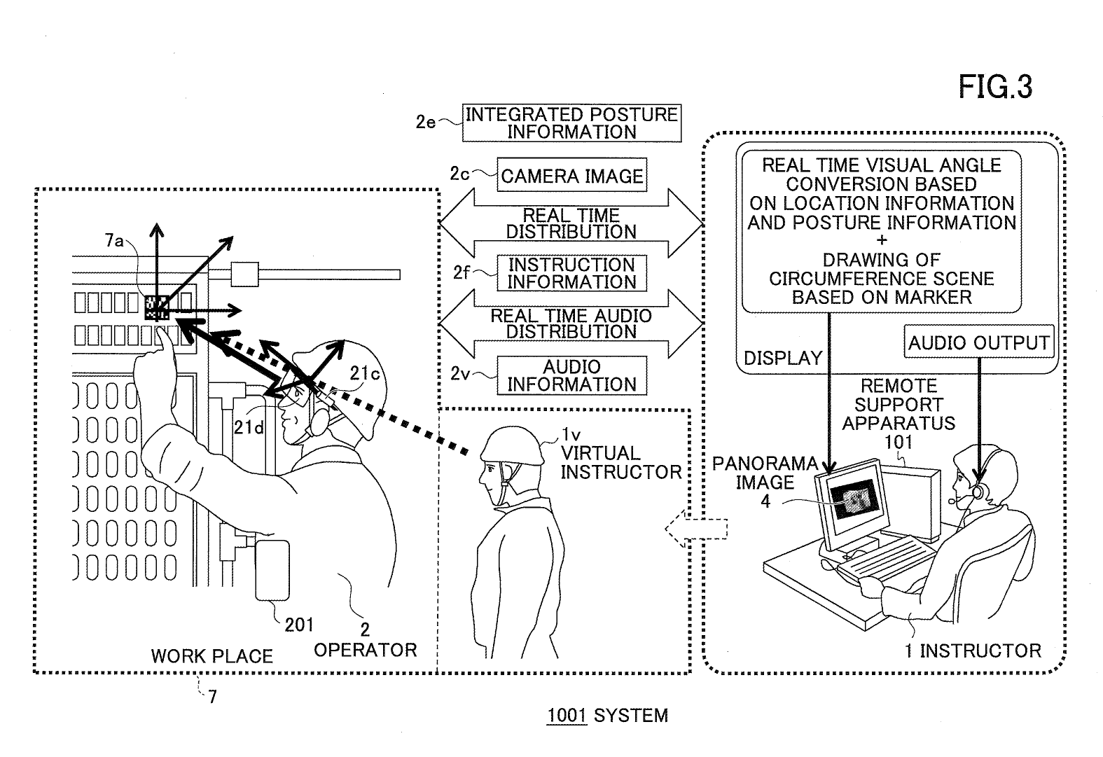

FIG. 3 is a diagram for explaining an operation supporting method in a first embodiment. In a system 1001 illustrated in the first embodiment depicted in FIG. 3, a marker 7a is placed at a location to be the reference point at a working place 7. The marker 7a is used as a reference object representing the reference point, and includes information to specify a location and a posture of the operator 2 from the camera image 2c captured by the camera 21c. An AR marker or the like may be used, but is not limited to the AR marker.

After the camera 21c of the operator 2 captures an area with a circumference including the marker 7a, multiple camera images 2c received from an operator terminal 201 are converted into a panorama image 4.

In a remote support apparatus 101, the marker 7a is detected by an image analysis and the reference point is defined. The multiple camera images 2c are arranged based on the reference point, and the multiple camera images 2c are overlaid based on feature points in each of the camera images 2c, so as to generate the panorama image 4.

Also, by recognizing the reference point in the camera image 2c, it is possible to calculate a visual line direction of the operator 2, and to acquire information pertinent to the location and the posture of the head of the operator 2.

The operation supporting method in the first embodiment will be briefly described. In the first embodiment, integrated posture information 2e generated based on the camera image 2c, and the camera image 2c captured by the camera 21c are distributed from the operator terminal 201 to the remote support apparatus 101 at real time. From the remote support apparatus 101, instruction information 2f, which the instructor 1 inputs by pointing on the panorama image 4, is distributed to the operator terminal 201. Also, audio information 2v between the operator 2 and the instructor 1 is also interactively distributed at real time.

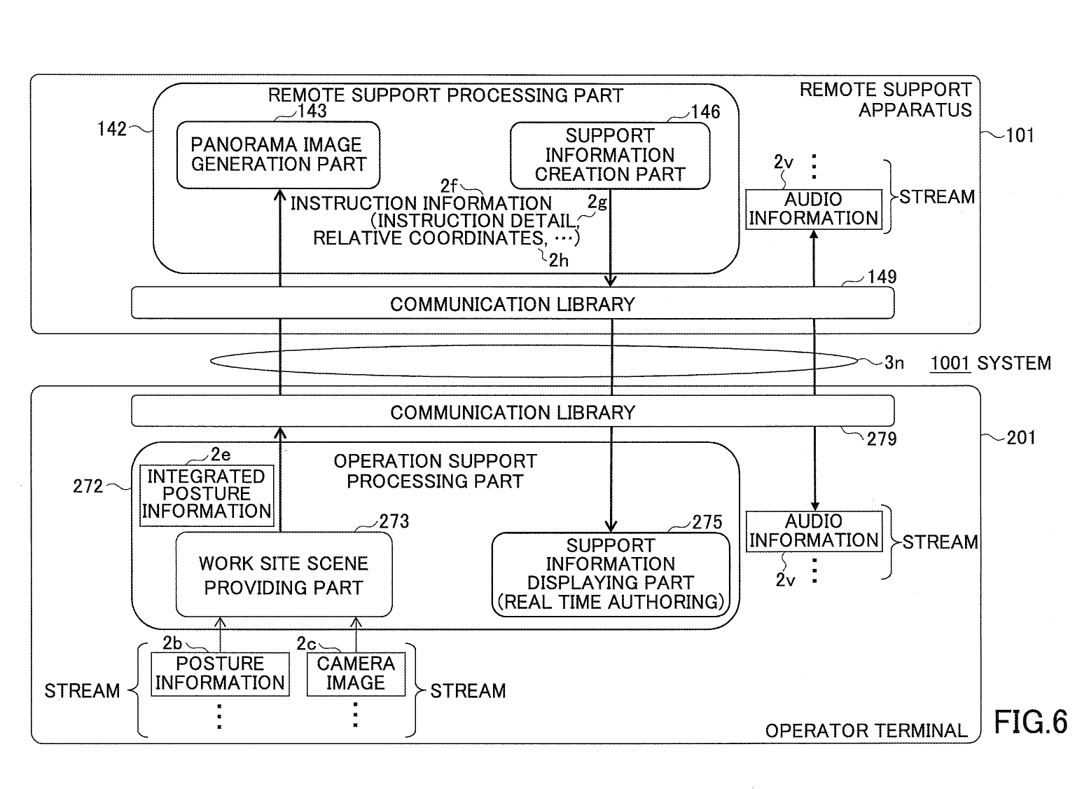

The posture information 2b (FIG. 6) approximately indicates a direction and an angle of the posture of the operator 2 which are measured at the remote support apparatus 101. The integrated posture information 2e is generated based on the posture information 2b (FIG. 6) and the camera image 2c. A detailed description will be given later.

The camera image 2c is captured by the camera 21c, and a stream of the multiple camera images 2c successively captured in time sequence is distributed as a video. The instruction information 2f corresponds to an indication to the operator 2, and support information pertinent to advice and the like, and includes an instruction detail 2g (FIG. 6) represented by letters, symbols, and the like, and information of relative coordinates 2h (FIG. 6) of a position where the instructor 1 points on the panorama image 4, and the like. The relative coordinates 2h indicates coordinates relative to a position of the marker 7a.

The remote support apparatus 101 in the first embodiment performs a visual angle conversion at real time based on the integrated posture information 2e received from the operator terminal 201, and draws a circumference scene of the operator 2 based on the information of the marker 7a specified by the image analysis of the camera image 2c. The drawn circumference scene is displayed as the panorama image 4 at the remote support apparatus 101.

The panorama image 4 is regarded as an image drawn by overdrawing the camera image 2c based on a relative location with respect to the location of the marker 7a by performing the visual angle conversion with respect to the camera image 2c provided by a real time distribution. Accordingly, in the panorama image 4, portions of the camera images 2c previously captured are retained and the camera image 2c in a current visual line direction of the operator 2 is displayed.

The panorama image 4 displays not only the camera image 2c in the current visual line direction of the operator 2 but also retains portions of the camera images 2c respective to previous visual line directions of the operator 2. It is possible for the instructor 1 to acquire more information regarding a peripheral environment of the operator 2. Also, it is possible for the instructor 1 to precisely point at the operation target outside a current visual field of the operator 2.

An operation of the instructor 1 on the panorama image 4 is sent to the operator terminal 201 at real time, and the instruction detail 2g is displayed at the display device 21d based on the instruction information 2f. The instruction detail 2g is overlapped with a scene at the working place 7 which the operator 2 views, and is displayed at the display device 21d. It is possible for the operator 2 to precisely recognize the operation target to operate.

Also, the instructor 1 accurately shares with the operator 2 the circumference at the working place 7, and comprehends the working place 7 as if the instructor 1 is actually at the working place 7. In the above points of view, the instructor 1 may correspond to a virtual instructor 1v who actually instructs the operator 2 at the working place 7.

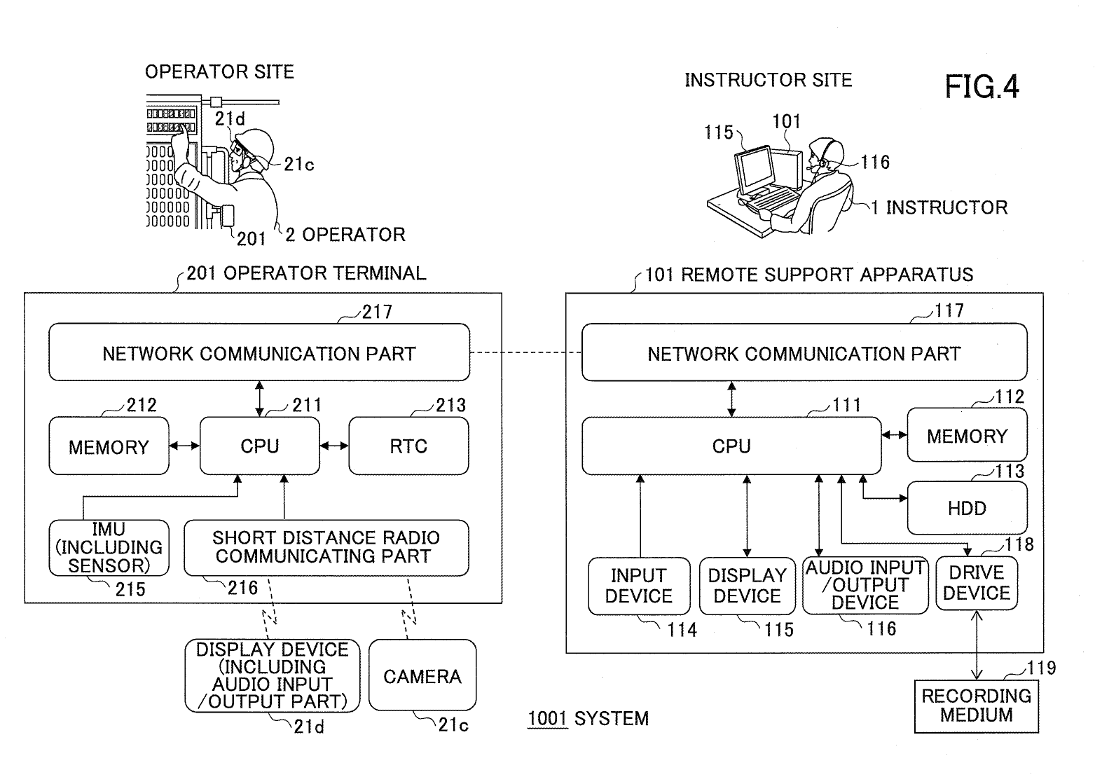

FIG. 4 is a diagram illustrating a hardware configuration of the system. In FIG. 4, the remote support apparatus 101 includes a Central Processing Unit (CPU) 111, a memory 112, a Hard Disk Drive (HDD) 113, an input device 114, a display device 115, an audio input/output part 116, a network communication part 117, and a drive device 118.

The CPU 111 corresponds to a processor that controls the remote support apparatus 101 in accordance with a program stored in the memory 112. A Random Access Memory (RAM), a Read Only Memory (ROM), and the like are used as the memory 112. The memory 112 stores or temporarily stores the program executed by the CPU 111, data used in a process of the CPU 111, data acquired in the process of the CPU 111, and the like.

The HDD 113 is used as an auxiliary storage device, and stores programs and data to perform various processes. A part of the program stored in the HDD 113 is loaded into the memory 112, and is executed by the CPU 111. Then, the various processes are realized.

The input device 114 includes a pointing device such as a mouse, a keyboard, and the like, and is used by the instructor 1 to input various information items for the process conducted in the remote support apparatus 101. The display device 115 displays various information items under control of the CPU 111. The input device 114 and the display device 115 may be integrated into one user interface device such as a touch panel or the like.

The audio input/output part 116 includes a microphone for inputting the audio sound such as voice and a speaker for outputting the audio sound. The network communication part 117 performs a wireless or wired communication via a network. Communications by the network communication part 117 are not limited to wireless or wired communications.

The program for realizing the process performed by the remote support apparatus 101 may be provided by a recording medium 119 such as a Compact Disc Read-Only Memory (CD-ROM).

The drive device 118 interfaces between the recording medium 119 (the CD-ROM or the like) set into the drive device 118 and the remote support apparatus 101.

Also, the recording medium 119 stores the program which realizes various processes according to the first embodiment which will be described later. The program stored in the recording medium 119 is installed into the remote support apparatus 101. The installed program becomes executable by the remote support apparatus 101.

It is noted that the recording medium 119 for storing the program is not limited to the CD-ROM. The recording medium 119 may be formed by a non-transitory or tangible computer-readable recording medium including a structure. In addition to the CD-ROM, a portable recording medium such as a Digital Versatile Disk (DVD), a Universal Serial Bus (USB) memory, a semiconductor memory such as a flash memory, or the like may be used as the computer-readable recording medium 119.

The operator 2 puts the operator terminal 201, the display device 21d, and the camera 21c on himself. The operator terminal 201 includes a CPU 211, a memory 212, a Real Time Clock (RTC) 213, an Inertial Measurement Unit (IMU) 215, a short distance radio communicating part 216, and a network communication part 217.

The CPU 211 corresponds to a processor that controls the operator terminal 201 in accordance with a program stored in the memory 212. A Random Access Memory (RAM), a Read Only Memory (ROM), and the like are used as the memory 212. The memory 212 stores or temporarily stores the program executed by the CPU 211, data used in a process of the CPU 211, data acquired in the process of the CPU 211, and the like. The program stored in the memory 212 is executed by the CPU 211 and various processes are realized.

The RTC 213 is a device that measures a current time. The IMU 215 includes an inertial sensor, and also, corresponds to a device that includes an acceleration measuring function and a gyro function. The IMU 215 acquires the posture information 2b (FIG. 6) indicating the posture of the operator 2.

The short distance radio communicating part 216 conducts short distance radio communications with each of the display device 21d and the camera 21c. The short distance communication may be Bluetooth (registered trademark) or the like. The network communication part 217 sends data such as the integrated posture information 2e generated by the posture information 2b and the camera image 2c by radio communications via the network, the camera images 2d, and the like to the remote support apparatus 101, and receives the instruction information 2f from the remote support apparatus 101.

The display device 21d includes a short distance radio communication function, and an audio input/output part. The display device 21d may be a wearable-type display device being eye glasses mounted towards the visual line direction on the head. The display device 21d includes a transparent display part. It is preferable for the operator 2 to visually observe a real view in the visual line direction. The display device 21d displays the instruction detail 2g included in the instruction information 2f received from the operator terminal 201 by the short distance wireless communication.

The camera 21c includes the short distance wireless communication function. The camera 21c is mounted on the head of the operator 2, captures a video in the visual line direction of the operator 2, and sends the camera images 2c to the operator terminal 201 by the short distance wireless communication. The camera 21c may be integrated with the display device 21d as a single device.

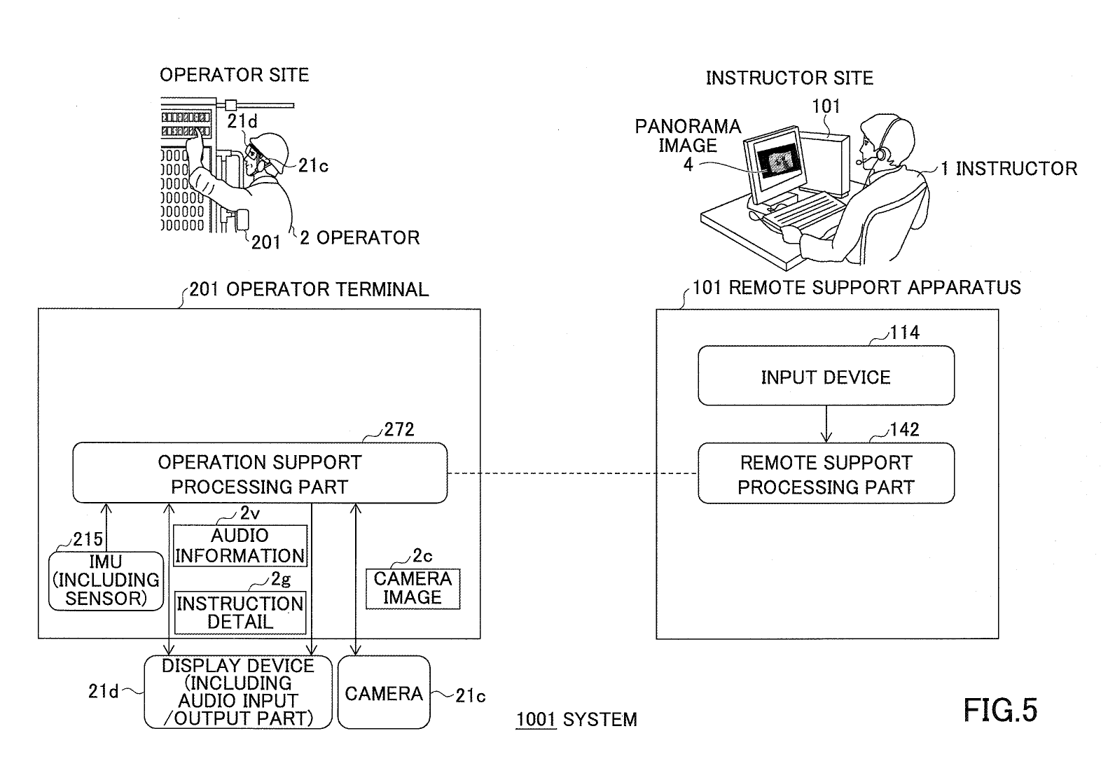

FIG. 5 is a diagram illustrating a functional configuration in the first embodiment. In FIG. 5, the remote support apparatus 101 in the system 1001, mainly includes a remote support processing part 142. The remote support processing part 142 is realized by the CPU 111 executing a corresponding program.

The remote support processing part 142 provides information regarding remote support interactively with an operation support processing part 272 of the operator terminal 201. The remote support processing part 142 displays the panorama image 4 based on the integrated posture information 2e and the camera images 2c received from the operator terminal 201, and sends the instruction information 2f based on location coordinates of the pointing of the instructor 1 received from the input device 114 to the operation support processing part 272.

The operator terminal 201 in the system 1001 mainly includes the operation support processing part 272. The operation support processing part 272 is realized by the CPU 211 executing a corresponding program, and provides information regarding the remote support interactively with the remote support processing part 142 of the remote support apparatus 101. The operation support processing part 272 acquires the posture information 2b (FIG. 6) from an IMU 215, generates the integrated posture information 2e by acquiring the camera images 2c from the camera 21c, and sends the integrated posture information 2e to the remote support processing part 142 of the remote support apparatus 101.

The operation support processing part 272 sends and receives the audio information 2v interactively with the remote support apparatus 101. The operation support processing part 272 sends the audio information 2v sent from the display device 21d, and sends the audio information 2v received from the remote support apparatus 101 to the display device 21d. Also, when receiving the instruction information 2f from the remote support processing part 142 of the remote support apparatus 101, the operation support processing part 272 displays the instruction detail 2g indicated in the instruction information 2f at the display device 21d based on the relative coordinates with respect to the reference point indicated in the instruction information 2f.

FIG. 6 is a diagram illustrating a part of the functional configuration depicted in FIG. 5. In FIG. 6, the operation support processing part 272 of the operator terminal 201 at a side of the operator 2 provides a current state in which the operator 2 is in order to acquire support from the instructor 1 at a remote place, and displays the instruction detail 2g provided by the instructor 1 at the display device 21d, so as to support the operator 2. The operation support processing part 272 mainly includes a work site scene providing part 273, and a support information display part 275.

The work site scene providing part 273 generates the integrated posture information 2e based on the posture information 2b and the camera image 2c, and sends the integrated posture information 2e to the remote support apparatus 101 through the network communication part 217.

The work site scene providing part 273 inputs a stream of the posture information 2b and a stream of the camera image 2c, and generates the integrated posture information 2e. The integrated posture information 2e is transmitted to the remote support apparatus 101 of the instructor 1 through the network communication part 217. The work site scene providing part 273 sequentially sends the camera images 2c to the remote support apparatus 101 through the network communication part 217.

The support information display part 275 displays the instruction detail 2g based on the relative coordinates 2h at the display device 21d in accordance with the instruction information 2f received from the remote support processing part 142 of the remote support apparatus 101 through the network communication part 217.

A communication library 279 of the operator terminal 201 is used in common among multiple processing parts included in the operator terminal 201, provides various functions to conduct communications through a network 3n, and interfaces between each of the processing parts and the network communication part 217.

The remote support processing part 142 of the remote support apparatus 101 of the operator 1 mainly includes a panorama image generation part 143, and a support information creation part 146.

The panorama image generation part 143 generates the panorama image 4 based on the multiple camera images 2c successively received through the network communication part 117 in the time sequence.

The support information creation part 146 creates the instruction information 2f to support the operation of the operator 2, and sends the instruction information 2f through the network communication part 117 to the operator terminal 201. Information of the instruction detail 2g, the relative coordinates 2h, and the like are displayed based on the instruction information 2f. The instruction detail 2g indicates a detail to support the operation of the operator 2 which is input from the input device 114 manipulated by the instructor 1. The relative coordinates 2h indicate a location of pointing on the panorama image 4 by the instructor 1 at a relative location with respect to the marker 7a.

A communication library 149 of the remote support apparatus 101 is used in common among the multiple processing parts included in the remote support apparatus 101, provides various functions for communications, and interfaces between each of the multiple processing parts and the network communication part 117.

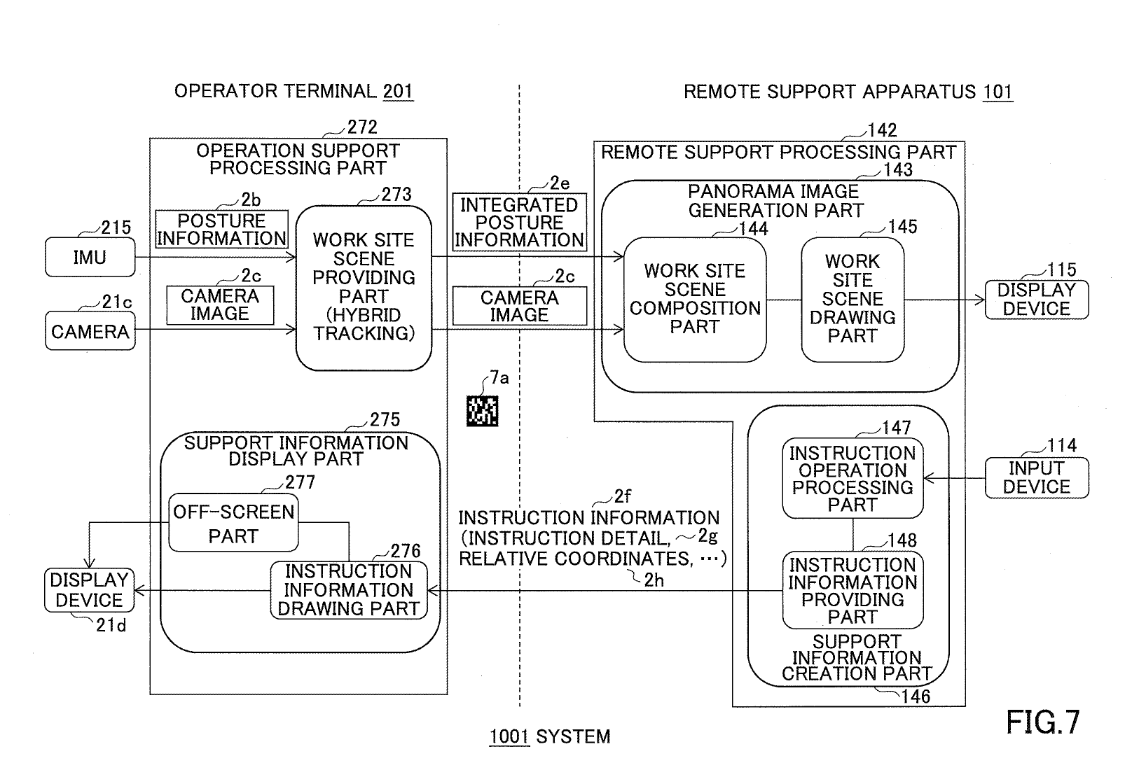

FIG. 7 is a diagram illustrating details of the functional configuration depicted in FIG. 6. In FIG. 7, generation and the support instruction of the panorama image 4 according to the first embodiment will be briefly explained. In FIG. 7, the operation support processing part 272 of the operator terminal 201 further includes the work site scene providing part 273, and the support information display part 275.

The work site scene providing part 273 inputs the posture information 2b provided from the IMU 215 and the camera image 2c received from the camera 21c, and conducts hybrid-tracking to generate the integrated posture information 2e. By the hybrid-tracking, even if the marker 7a becomes out of the visual range, a successive tracking is conducted. The integrated posture information 2e being output is transmitted to the remote support apparatus 101 through the network communication part 217.

The work site scene providing part 273 recognizes the marker 7a by performing an image process with respect to each of the camera images 2c successively received from the camera 21c, and generates the integrated posture information 2e by using the information of a location and a posture of the operator 2 acquired by sequentially calculating a movement distance of a visual line of the operator 2 from the marker 7a, and the posture information 2b indicating a movement (that is, acceleration) of the operator 2 measured by the IMU 215. The integrated posture information 2e is sent to the remote support apparatus 101 at an instructor site through the network communication part 217. Also, the work site scene providing part 273 successively sends the camera images 2c to the remote support apparatus 101 through the network communication part 217.

The support information display part 275 displays the instruction detail 2g from the instructor 1 of the remote place at the display device 21d, and includes an instruction information drawing part 276, and an off-screen part 277.

The instruction information drawing part 276 draws the instruction detail 2g of the instructor 1 based on the relative coordinates 2h by using the instruction information 2f received from the remote support apparatus 101. In a case in which the relative coordinates 2h indicate outside a current visual field of the operator 2, the off-screen part 277 conducts a guiding display to guide the operator 2 toward the relative coordinates 2h. The instruction information drawing part 276 displays the instruction detail 2g at the display device 21d.

At the instructor site, the remote support processing part 142 of the remote support apparatus 101 mainly includes a panorama image generation part 143, and a support information creation part 146.

The panorama image generation part 143 further includes a work site scene composition part 144, and a work site scene drawing part 145. The work site scene composition part 144 generates the panorama image 4 representing an appearance of the circumference at the work site of the operator 2, by processing and composing the multiple camera images 2c in a marker coordinate system based on the relative location from the reference point as the location of the marker 7a is set as the reference point. The work site scene drawing part 145 draws the panorama image 4 generated by the work site scene composition part 144 at the display device 115.

The support information creation part 146 further includes an instruction operation processing part 147, and an instruction information providing part 148. When receiving input of the instruction detail 2g such as pointed location coordinates, text, and the like by the instructor 1 at the input device 114, the instruction operation processing part 147 reports information of the location coordinates, the text, and the like to the instruction information providing part 148.

The instruction information providing part 148 converts the location coordinates reported from the instruction operation processing part 147 into the relative coordinates 2h from the reference point, generates the instruction information 2f indicating the instruction detail 2g reported from the instruction operation processing part 147 and the relative coordinates 2h acquired by the conversion, and sends the instruction information 2f to the operator terminal 201.

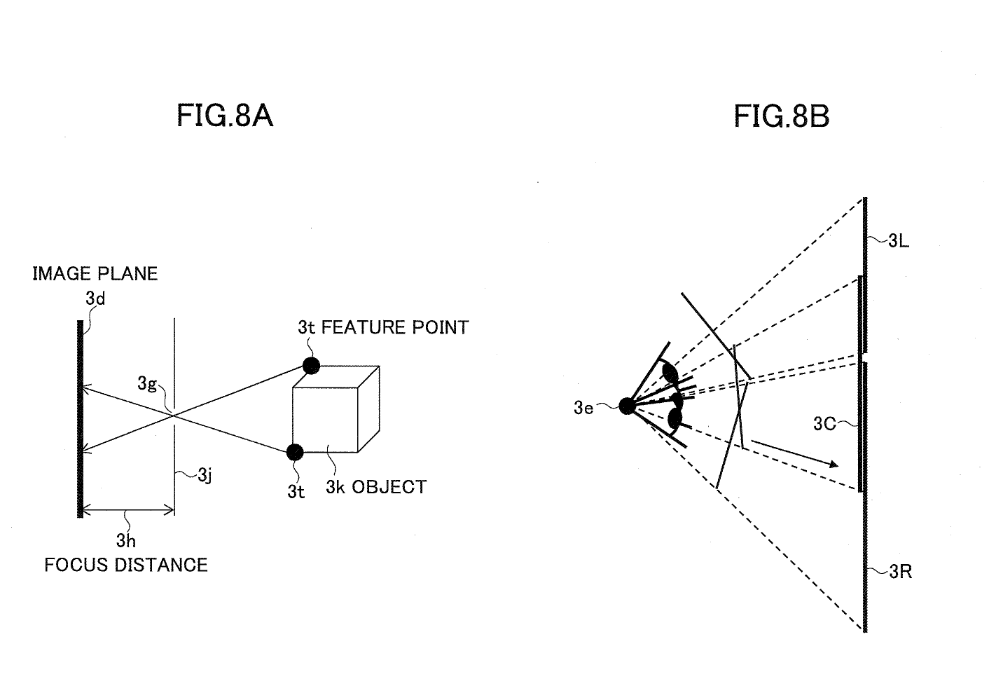

Next, a principle of the panorama image generation is described. FIG. 8A and FIG. 8B are diagrams illustrating the principle of the panorama image generation. FIG. 8A depicts a principle of a pin hole camera model. An object 3k is projected onto an image plane 3d by setting the image plane 3d to which an image of the object 3k is projected and a plane 3j having a pin hole 3g distanced at a focal length. Light from feature points 3t of the object 3k is displayed on the image plane 3d through the pin hole 3g.

FIG. 8B is a diagram for explaining a condition of a movement of the camera. In FIG. 8B, the camera 21c is put on the head of the operator 2. Hence, when the operator 2 moves the head right and left, an imaging range of the camera 21c is a range 3C when the head of the operator 2 faces forward, a range 3L when the head of the operator 2 faces left, and a range 3R when the head of the operator 2 faces right. As depicted in FIG. 8B, it is assumed that a rotation center 3e of the camera 21c is approximately fixed.

Based on the principle of the pin hole camera model illustrated in FIG. 8A, and as the rotation center 3e of the camera 21c illustrated in FIG. 8B is fixed, the panorama image 4 is generated.

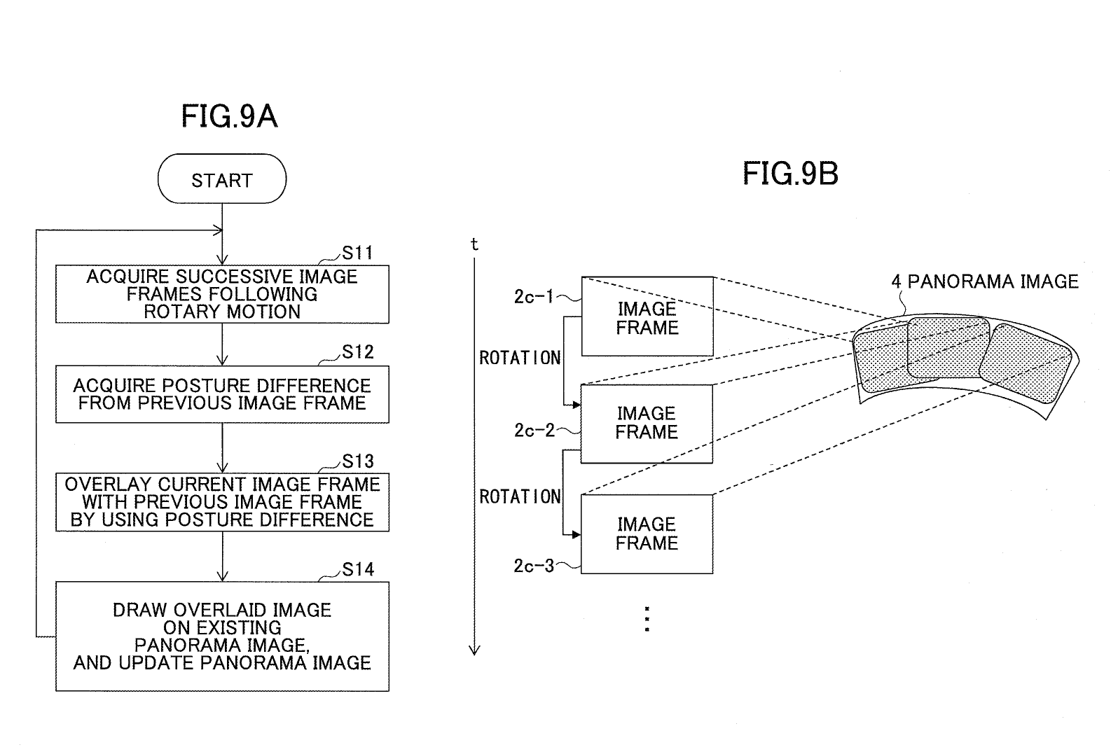

FIG. 9A and FIG. 9B are diagrams for explaining a panorama image generation process. FIG. 9A illustrates a flowchart for explaining the panorama image generation process, and FIG. 9B illustrates an example of an overlay of image frames. Referring to FIG. 9B, in FIG. 9A, the panorama image generation process conducted by the panorama image generation process part 143 will be described. Each time a rotation movement is detected, the following steps S11 through S14 are conducted as described below.

In the panorama image generation part 143, the work site scene composition part 144 successively acquires image frames 2c-1, 2c-2, 2c-3, and the like (FIG. 9B) in accordance with the rotation movement (step S11).

After that, the work site scene composition part 144 acquires a posture difference between a previous image frame and a current image frame (step S12), and overlays the current image frame with the previous image frame by using the acquired posture difference (step S13). The entirety or a part of the current image frame being overlapped with the previous image frame is overwritten on the previous image frame, so as to compose the previous frame image and the current image frame.

Next, the work site scene drawing part 145 draws an overlapped image on the panorama image 4, and updates the panorama image 4 (step S14).

In FIG. 9B, the image frames 2c-1, 2c-2, 2c-3, and the like correspond to the respective camera images 2c. The image frames 2c-1, 2c-2, 2c-3, and the like are successively captured depending on the rotation of the head of the operator 2. In an order of lapse of time t, a part of the image frame 2c-1 is overwritten by the image frame 2c-2, and a part of the image frame 2c-2 is overwritten by the image frame 2c-3.

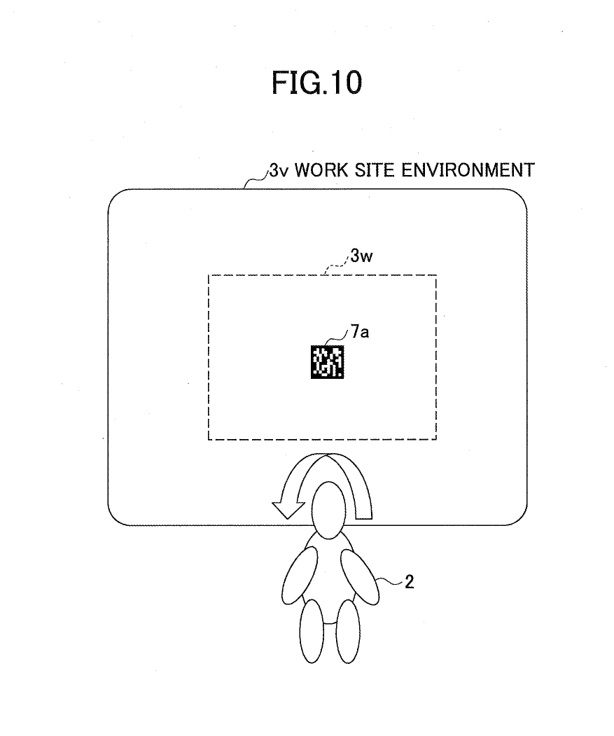

FIG. 10 is a diagram illustrating an example of a marker visible range. The marker visible range 3w depicted in FIG. 10 corresponds to a range where the marker 7a is included in the camera image 2c captured by the camera 21c mounted on the head of the operator 2 in a work environment 3v in which the marker 7a is placed.

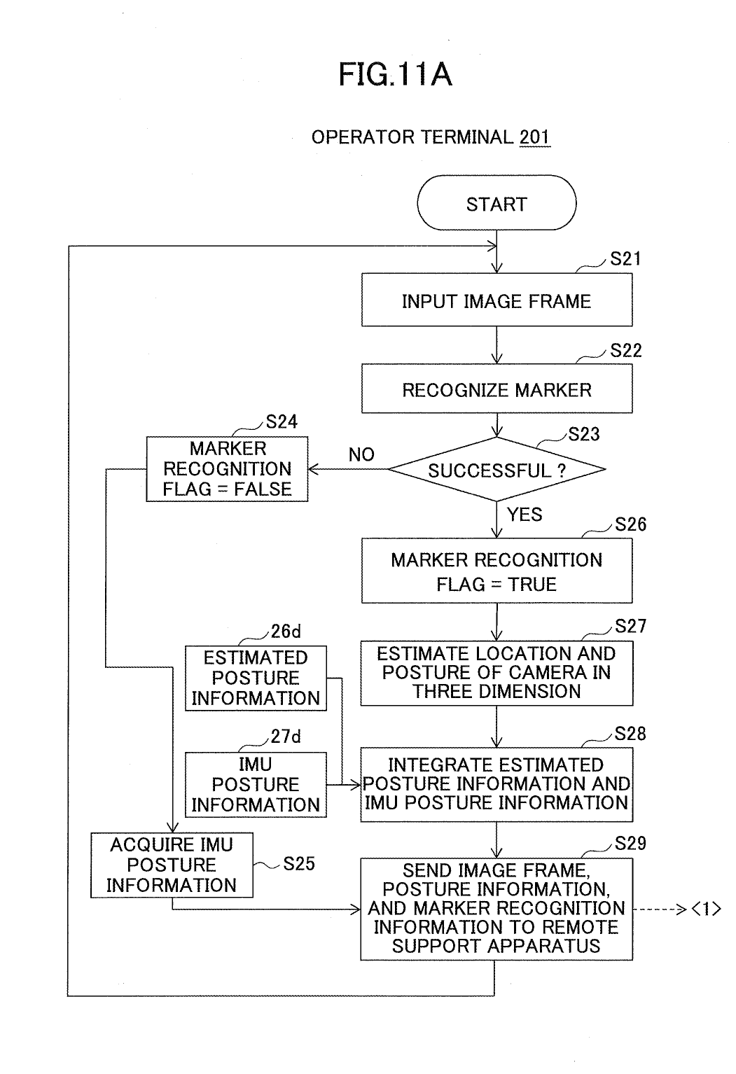

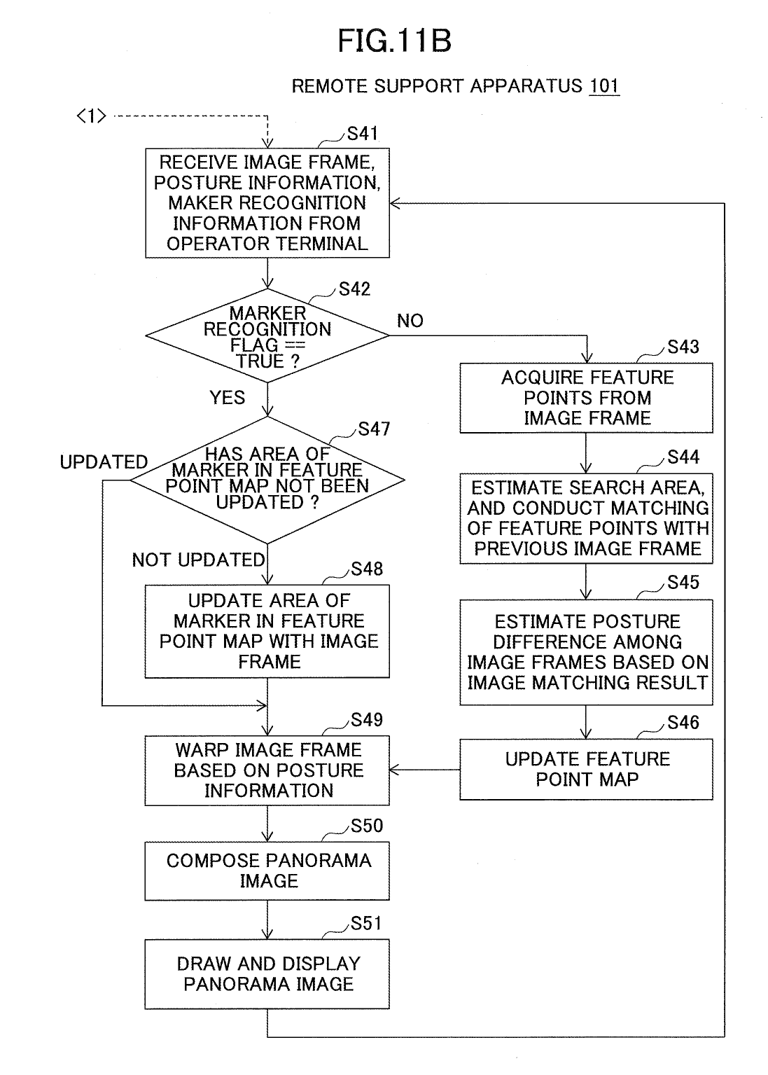

Next, a process until the panorama image 4 is displayed at the remote support apparatus 101 in the system 1001 will be described with reference to FIG. 11A and FIG. 11B. FIG. 11A and FIG. 11B are flowcharts for explaining a display process of the panorama image in the system.

In FIG. 11A, when the operator terminal 201 receives the image frame (the camera image 2c) through the short distance radio communicating part 216, the work site scene providing part 273 inputs the image frame (step S21), and recognizes the marker 7a by the image process (step S22).

Then, the work site scene providing part 273 determines whether a marker recognition is successful (step S23). When the marker recognition has failed, that is, when the marker 7a does not exist in the received image frame, the work site scene providing part 273 sets the marker recognition flag to “FALSE” (step S24), acquires IMU posture information 27d measured by the IMU 215, and sets the IMU posture information 27d as the posture information 2b to be sent to the remote support apparatus 101 (step S25). The work site scene providing part 273 advances to step S29.

On the other hand, when the marker recognition is successful, that is, when the marker 7a exists in the received image frame, the work site scene providing part 273 sets the marker recognition flag to “TRUE” (step S26), and estimates a location and a posture of the camera 21c at the work place 7 in three dimensions by using a result from recognizing the marker 7a (step S27). Estimated posture information 26d indicating the estimated three dimensional location and posture is temporarily stored in the memory 212.

The work site scene providing part 273 integrates the estimated posture information 26d and the IMU posture information 27d measured by the IMU 215 (step S28). The integrated posture information 2e acquired by integrating the estimated posture information 26d and the IMU posture information 27d is set as the posture information to be sent to the remote support apparatus 101.

The work site scene providing part 273 sends the image frame (the camera image 2c), the posture information, and marker recognition information to the remote support apparatus 101 (step S29). The integrated posture information 2e and the IMU posture information 27d are sent as the posture information. Then, the work site scene providing part 273 returns to step S21 to process a next image frame, and repeats the above described process.

In FIG. 11B, when the remote support apparatus 101 receives the image frame (the camera image 2c), the posture information, and the marker recognition information from the operator terminal 201 through the network communication part 117 (step S41), the work site scene composition part 144 of the panorama image generation part 143 determines whether the marker recognition flag in the marker recognition information indicates “TRUE” (step S42).

When the marker recognition flag in the marker recognition information indicates “FALSE” (NO of step S42), the work site scene composition part 144 acquires feature points by conducting the image process to the current image frame (step S43), estimates a search area by using the previous image frame and the current image frame, and conducts a feature point matching process for matching the feature points among the previous image frame and the current image frame (step S44).

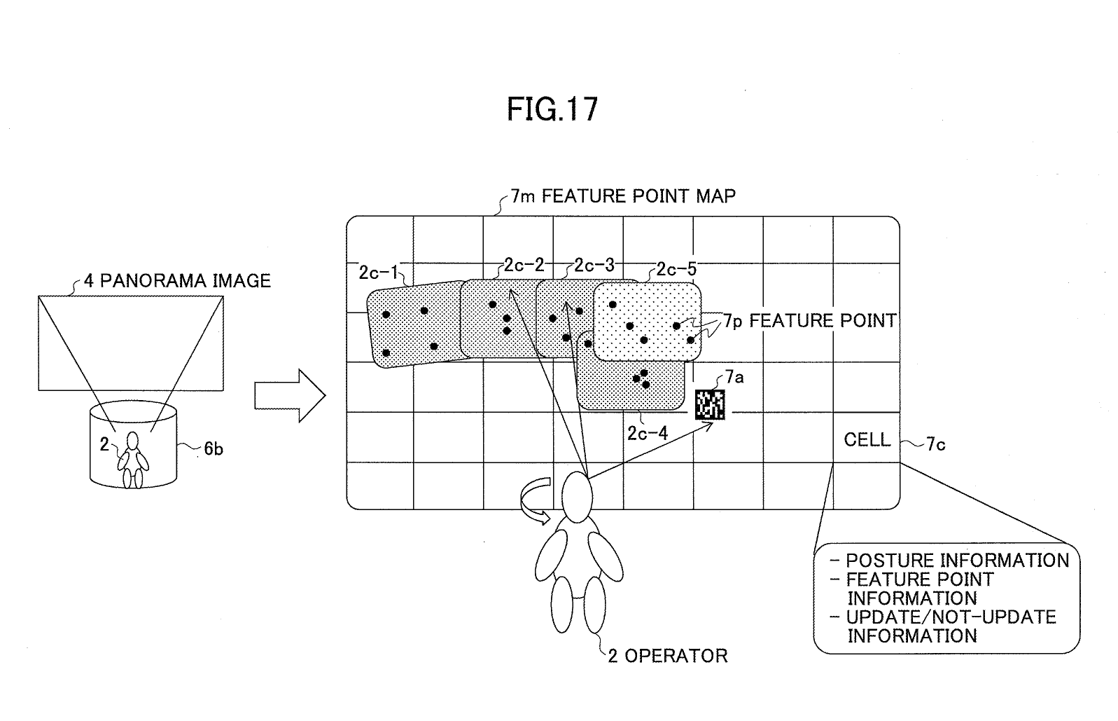

The work site scene composition part 144 estimates the posture difference between the previous image frame and the current image frame based on the image matching result acquired in step S44 (step S45), and updates a feature point map 7m (FIG. 17) (step S46). After that, the work site scene composition part 144 advances to step S49.

On the other hand, when the marker recognition flag of the marker recognition information indicates “TRUE” (YES of step S42), the work site scene composition part 144 determines whether an area of the marker 7a in the feature point map 7m has been updated (step S47). When the area of the marker 7a is updated, the work site scene composition part 144 advances to step S49.

On the other hand, when the area of the marker 7a has not been update, the work site scene composition part 144 updates the area of the marker 7a in the feature point map 7m with information acquired from the received image frame (step S48).

When it is determined in step S47 that the area of the marker 7a is updated, after step S48 or the update of the feature point map 7m in step S46, the work site scene composition part 144 deforms (warps) the image frame based on the posture information received from the operator terminal 201 (step S49), and composes the deformed image frame with the image frames which have been processed (step S50).

After that, the work site scene drawing part 145 draws and displays the panorama image 4 (step S51). Then, the panorama image generation part 143 goes back to step S41, and conducts the above described process with respect to a next image frame received through the network communication part 117.

The configuration example in which the integrated posture information 2e is created at the operator terminal 201 is described above. Alternatively, the estimated posture information 26d and the IMU posture information 27d may be sent as the posture information to the remote support apparatus 101. At the remote support apparatus 101, when the marker recognition flag indicates “TRUE”, before step S49, the integrated posture information 2e may be acquired by integrating the estimated posture information 26d and the IMU posture information 27d.

Next, a method for acquiring the reference point by calculating three dimensional location coordinates of the marker 7a will be considered. To acquire the reference point, it may be considered to calculate three dimensional location information by conducting a visual process (Non-Patent Document 3).

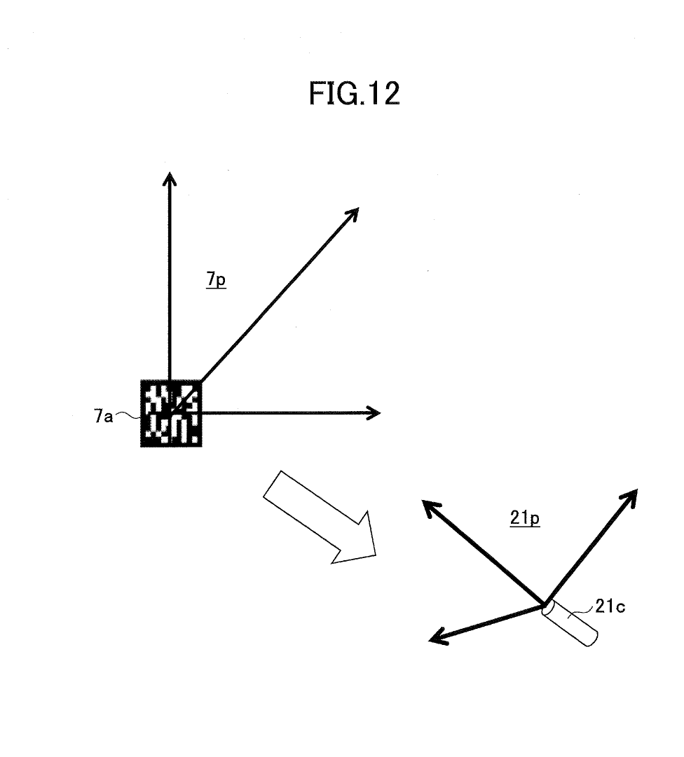

The method for acquiring the reference point will be described with reference to FIG. 12. FIG. 12 is a diagram for explaining a coordinate conversion. In FIG. 12, first, a marker area is extracted from an input image frame, and coordinate values of four apexes of the marker 7a are acquired in an ideal screen coordinate system. Accordingly, a marker detection process is conducted to specify the marker 7a by pattern recognition. After that, a coordinate conversion matrix is acquired to convert the coordinate values of the four apexes into the three dimensional location coordinates. That is, the coordinate conversion matrix from a marker coordinate system 7p into a camera coordinate system 21p is acquired.

However, in this method, if the image frame does not include an image portion of the marker 7a (that is, the marker area), the coordinate conversion matrix from the marker coordinate system to the camera coordinate system is not acquired. In the first embodiment, in addition to acquiring the information of the location and the posture of the head of the operator 2 from the image frame by the marker recognition, the hybrid tracking which tracks the posture of the head of the operator 2 is conducted by using information of an inertial sensor. Hence, even if the image frame does not include the marker area, it is possible to track the posture of the head.

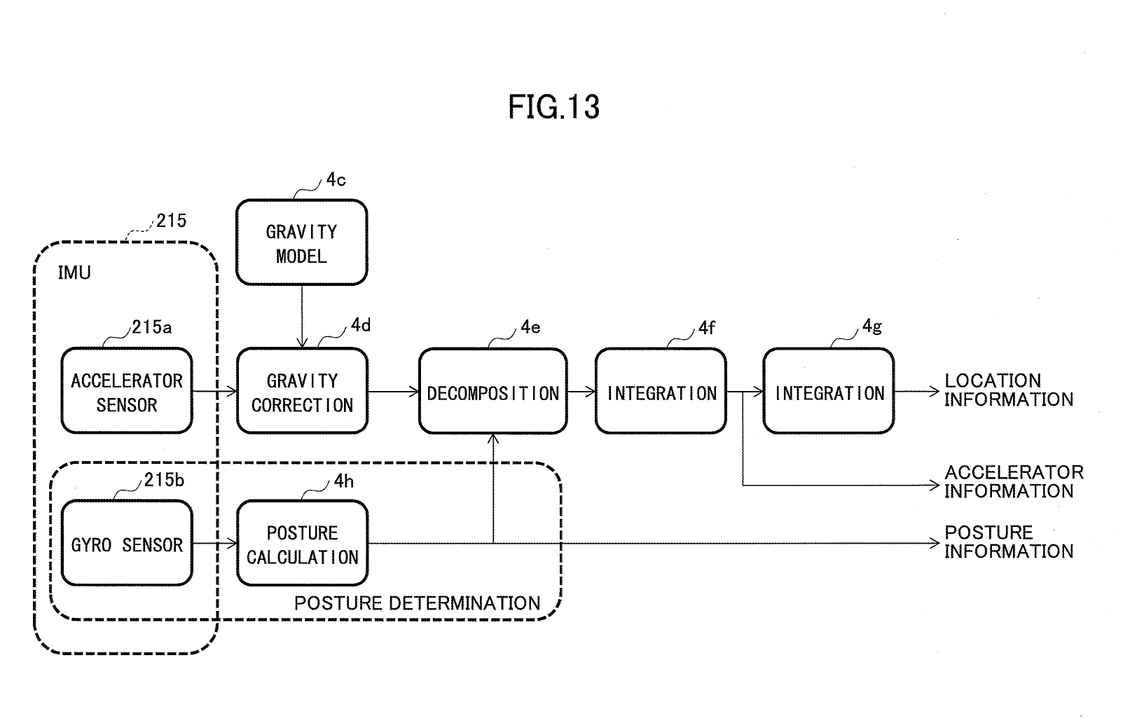

FIG. 13 is a diagram illustrating a configuration for acquiring the information of the location and the posture by using the IMU. In FIG. 13, the IMU 215 corresponds to an inertial sensor device, and includes an accelerator sensor 215a and a gyro sensor 215b. With respect to accelerator information acquired by the accelerator sensor 215a, a gravity correction 4d is conducted by using a gravity model 4c.

On the other hand, with respect to angular rate information acquired by the gyro sensor 215b, by conducting a posture calculation 4h, the posture information is acquired.

By referring to the posture information, the acceleration information acquired by the gravity correction 4d is decomposed into various components (4e), and a gravity component is acquired. By calculating an integral of the gravity component (4f), velocity information is acquired. Further, by calculating the integral of the velocity information (4g), the location information is acquired.

Calculations of the gravity correction 4d, the decomposition 4e, the integral calculation 4f, the integral calculation 4g, and the posture calculation 4h are realized by the CPU 211 executing corresponding programs. These calculations may be realized partially or entirely by hardware such as circuits.

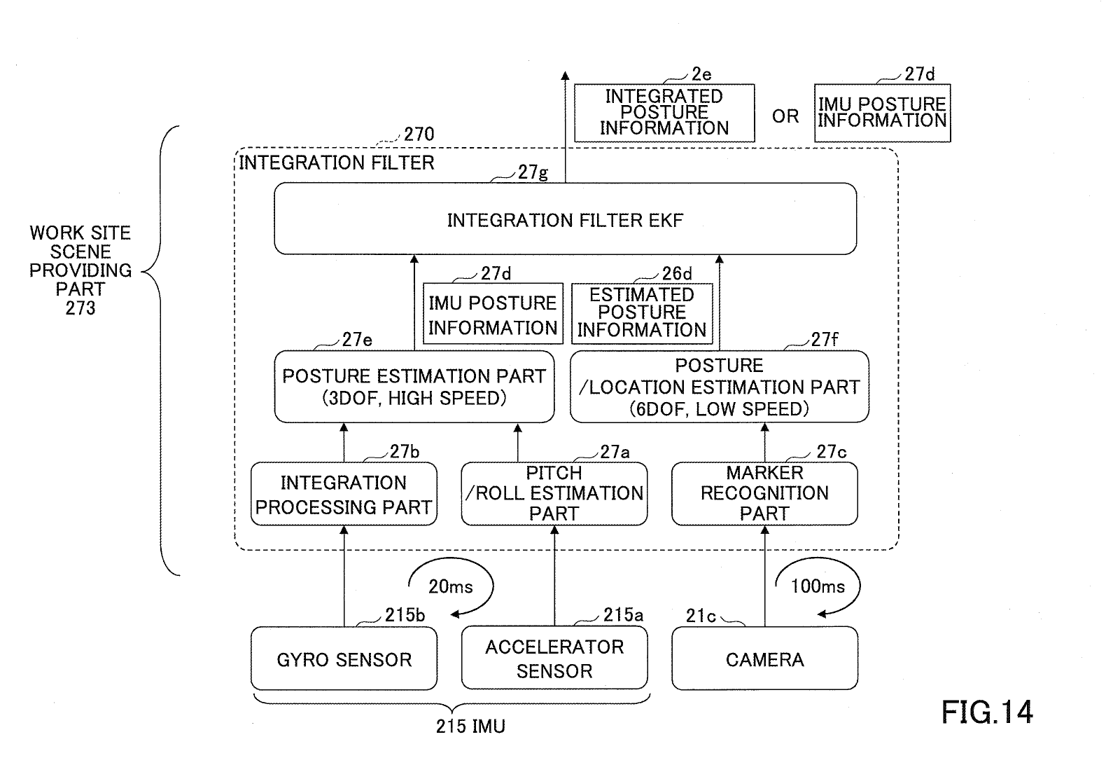

An integration filter realizing the hybrid tracking in the first embodiment will be described with reference to FIG. 14. FIG. 14 is a diagram illustrating a configuration example of the integration filter. In FIG. 14, the work site scene providing part 273 includes an integration filter 270 to realize the hybrid tracking.

The integration filter 270 inputs sets of sensor information from an accelerator sensor 215a of the IMU 215 and a gyro sensor 215b, and the image frame from the camera 21c. The integration filter 270 includes a pitch/roll estimation part 27a, an integration processing part 27b, a marker recognition part 27c, a posture estimation part 27e, a posture/location estimation part 27f, and an integration filter EFK (Extended Kalman Filter) 27g.

The pitch/roll estimation part 27a estimates a pitch and a roll based on the acceleration information acquired from the accelerator sensor 215a. The integration processing part 27b conducts an integral process with respect to the angular rate information acquired from the gyro sensor 215b. The posture estimation part 27e inputs the acceleration information and a result from calculating the integral of the angular rate information, and outputs the posture information indicating a result from estimating the posture of the operator 2.

The marker recognition part 27c recognizes the marker 7a from the image frame acquired from the camera 21c. When the marker 7a is recognized by the marker recognition part 27c, that is, when the marker recognition flag indicates “TRUE”, the posture and the location are estimated by using the image frame. The estimated posture information 26d is output. The marker recognition flag indicates “FALSE”, a process by the posture/location estimation part 27f is suppressed and is not processed.

When the marker recognition flag indicates “TRUE”, the integration filter EFK 27g receives the estimated posture information 26d and the IMU posture information 27d as input values, and precisely estimates the posture of the operator 2 by using the integration filter EFK 27g which is the Extended Kalman Filter. By the integration filter EFK 27g, it is possible to acquire the integrated posture information 2e in which an estimation error of the posture of the operator 2 is reduced. Hence, the integrated posture information 2e, which indicates the result from estimating the posture of the operator 2 by the integration filter EKF 27g, is output.

When the marker recognition flag indicates “FALSE”, the integration filter EFK 27g does not conduct an integration process in which the estimated posture information 26d and the IMU posture information 27d are used as the input values. Instead, the posture information 27d alone is output from the integration filter 270.

The posture estimation part 27e estimates the posture of three degrees of freedom, which is less than six degree of freedom of the posture/location estimation part 27f conducting the image process. It is possible for the posture estimation part 27e to estimate the posture faster than the posture/location estimation part 27f. Even if the marker recognition flag indicates “FALSE”, it is possible to distribute the posture information faster to the remote support apparatus 101.

Also, imaging by the camera 21c is approximately every 100 ms. On the other hand, the IMU 215 outputs sensor information every 20 ms. Instead of waiting to receive a next accurate integrated posture information 2e, the IMU posture information 27d is received. Thus, it is possible to timely update the panorama image 4.

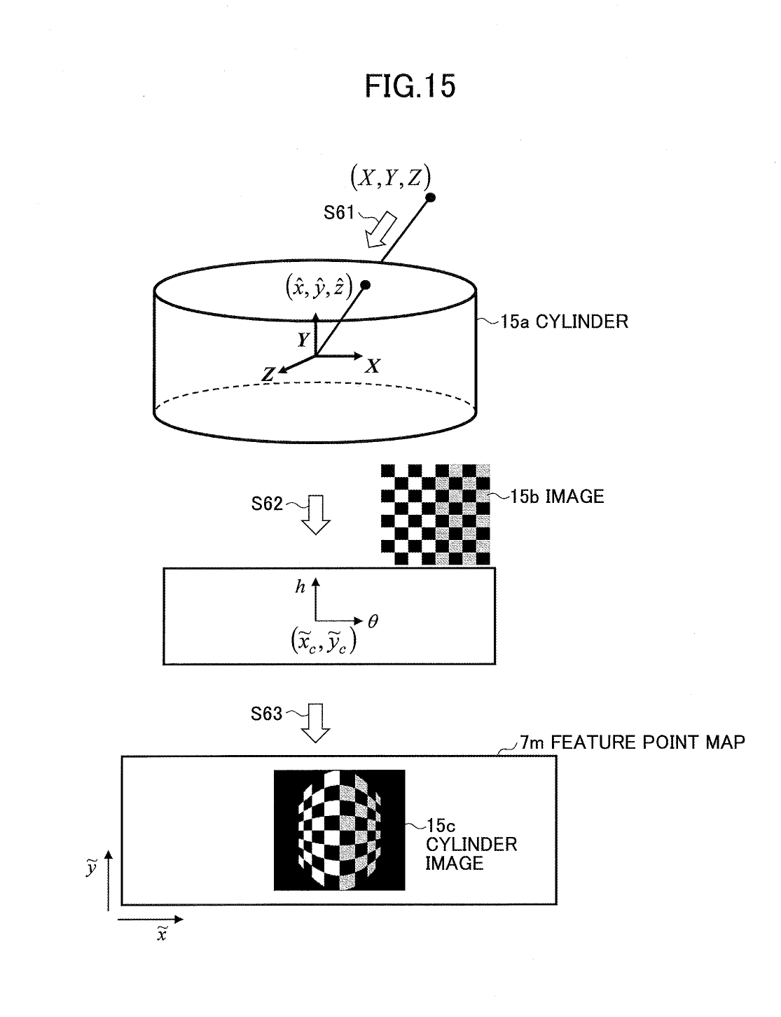

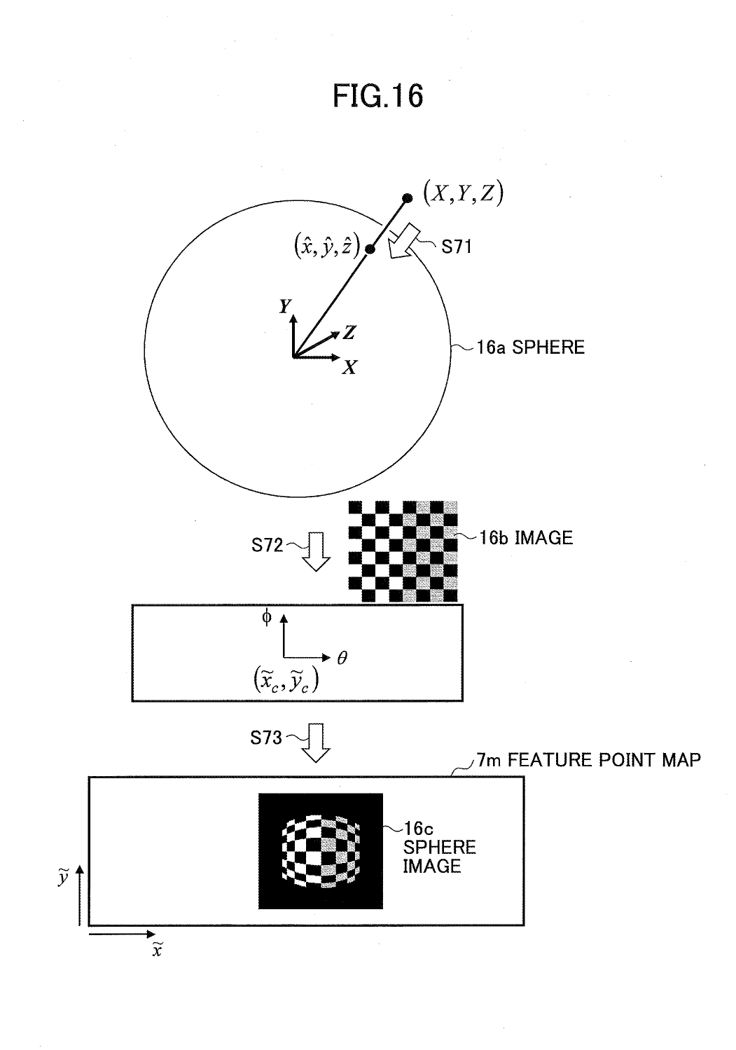

Next, a coordinate conversion in a case of generating the panorama image 4 in the remote support apparatus 101 will be described with reference to FIG. 15 and FIG. 16. FIG. 15 is a diagram for explaining a projection onto a cylinder.

In FIG. 15, first, by using the following equation (1):

$$( \hat{x} , \hat{y} , \hat{z} ) = \frac{1}{\sqrt{{X}^{2} + {Z}^{2}}} ( X , Y , Z ) , \qquad ( 1 )$$

three dimensional coordinates (X, Y, Z) are projected to a cylinder 15a (step S61). The cylinder 15a may be a unit cylinder.

Next, an equation (2) is used to convert into a cylinder coordinate system (step S62).

(sin θ,h, cos θ)=(\hat{x},ŷ,\hat{z}) (2)

Then, an equation (3) is used to convert into a cylinder image coordinate system (step S63).

(\tilde{x},\tilde{y})=(fθ,fh)+(\tilde{x}_{c},\tilde{y}_{c}) (3)

In the equation (3), an image sequence at a rotation is given by an offset of the cylinder coordinate system.

By the above calculations, an image 15b is converted into a cylinder image 15c. Feature points of the cylinder image 15c are recorded in the feature point map 7m, which will be described below, depending on the cylinder image 15c.

FIG. 16 is a diagram for explaining a projection to a sphere. In FIG. 16, first, by using the following equation (4):

$$( \hat{x} , \hat{y} , \hat{z} ) = \frac{1}{\sqrt{{X}^{2} + {Y}^{2} + {Z}^{2}}} ( X , Y , Z ) , \qquad ( 4 )$$

the three dimensional coordinates (X, Y, Z) are projected into a sphere 16a (step S71).

Next, the following equation (5) is used to convert into a sphere coordinate system (step S72):

(sin θ cos , sin φ, cos θ cos φ)=(\hat{x},ŷ,\hat{z}) (5).

Then, an equation (6) is used to convert into a sphere image coordinate system (step S73).

(\tilde{x},\tilde{y})=(fθ,fh)+(\tilde{x}_{c},\tilde{y}_{c}) (6).

In the equation (6), the image sequence at the rotation is given by an offset of the sphere coordinate system.

Next, the feature point map 7m created during the generation of the panorama image 4 will be described. FIG. 17 is a diagram for explaining the feature point map. In FIG. 17, a view seen from the operator 2 rotating the head at 360° right and left may be represented by an image projected onto a side surface of a cylinder 6b in a case in which the operator 2 stands at a center on a bottom surface of a circle.

In the first embodiment, the panorama image 4 corresponds to an image drawn based on multiple images 2c-1, 2c-2, 2c-3, 2c-4, 2c-5, and the like captured by the camera 21c while the operator 2 is rotating the head, among images which may be projected on the side surface of the cylinder 6b

The feature point map 7m will be briefly described. As a case in which the operator 2 moves the head and changes the posture, a correspondence between the image frames 2c-1, 2c-2, 2c-3, 2c-4, and 2c-5 successively captured by the camera 21c and the feature point map 7m is illustrated in FIG. 17.

The feature point map 7m includes multiple cells 7c. The multiple cells 7c correspond to multiple regions into which the panorama image 4 is divided. Feature points 7p detected from each of the image frames 2c-1 through 2c-5 are stored in respective cells 7c corresponding to the relative locations from the marker 7a.

The posture information, feature point information, update/not-update information, and the like are stored in each of the cells 7c. A size of an area to store in each of the cells 7c is smaller than an image range for each of the image frames 2c-1 to 2c-5.

In FIG. 17, the cylinder 6b is illustrated as the rotation of the head right and left is an example. It may be assumed that the head is located at a center point and is rotated at 360° to any direction. In this case, the panorama image 4 is presented as an image projected to a half sphere or a sphere. The feature point map 7m includes cells 7c respective to regions into which a surface of the half sphere or the sphere is divided.

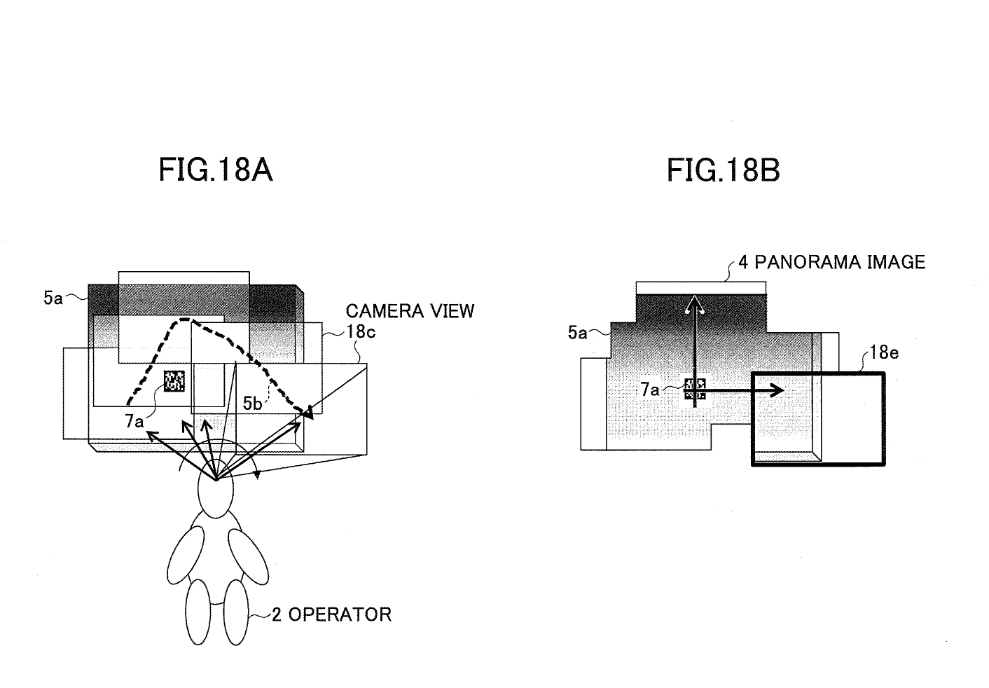

FIG. 18A and FIG. 18B are diagrams for explaining a display method of the panorama image based on the movement of the head of the operator. In FIG. 18A, camera views 18c of the camera 21c are illustrated in a case in which the head of the operator 2 is moved with respect to an object 5a as indicated by a curved line 5b.

Five images captured in the camera views 18c are arranged based on the relative locations with respect to the marker 7a, and the rotation is given depending on the posture difference. These five images are overwritten in the time sequence by matching the same feature points to each other. The panorama image 4 is formed in a shape as illustrated in FIG. 18B.

In the first embodiment, a latest camera image 18e is depicted by emphasizing edges so as to easily recognize a region thereof. The region of the latest camera image 18e corresponds to the camera view 18c. The latest camera image 18e is specified in the panorama image 4. Hence, it is possible for the instructor 1 to easily determine an area where a view point of the operator 2 locates, and to easily instruct the operator 2.

As described in FIG. 18A, the visual line direction of the operator 2, and a movement of the visual line are not restricted and are free in the first embodiment. As illustrated in FIG. 18B, it is possible to entirely comprehend the circumference at the work site of the operator 2 while the view point of the indicator 1 is retained. Furthermore, by drawing multiple image frames by associating with the visual line of the operator 2 in the panorama image 4, it is possible for the operator 2 and the instructor 1 to share and comprehend the environment with less restriction between them.

Also, in a panorama image generation process according to the first embodiment, by the hybrid tracking of the head of the operator 2, it is possible to predict the movement of the head. By narrowing a feature range among the image frames, it is possible to realize an increase of speed of the panorama image generation process.

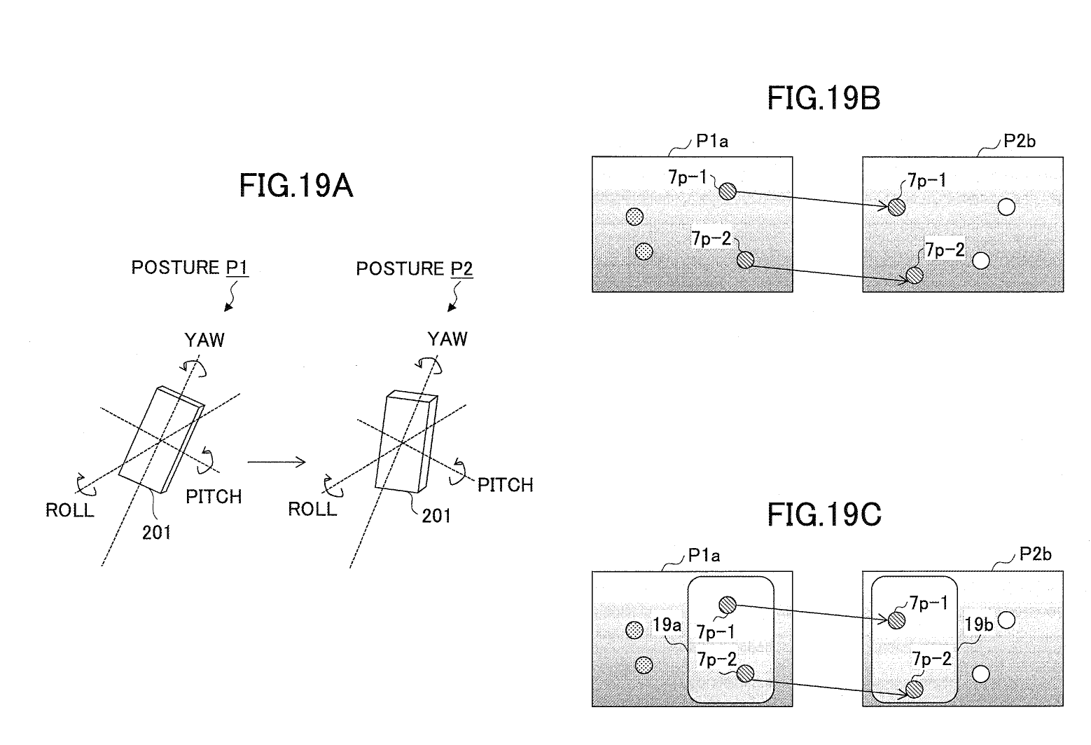

FIG. 19A, FIG. 19B, and FIG. 19C are diagrams for explaining speed-up of the panorama image generation process. In FIG. 19A, a state example of the operator terminal 201, in which the operator 2 changes an inclination from a posture P1 to a posture P2, is depicted.

FIG. 19B illustrates an example of a feature point search. The same feature points 7p-1 and 7p-2 existing in both an image frame P1a at the posture P1 and an image frame P2a at the posture P2 are searched for in the entire images. In this case, time is consumed for a search process.

In the first embodiment, as depicted in FIG. 19C, a search area 19a and a search area 19b are respectively predicted in both the image frame P1a and the image frame P2b based on a rotational speed and a rotation direction. By searching for feature points in both the image frame P1a and the image frame P2b, the same feature points 7p-1 and 7p-2 are specified.

At the remote support apparatus 101, the work site scene composition part 144 of the panorama image generation part 143 predicts the search area 19a and the search area 19b, and specifies the same feature points 7p-1 and 7p-2.

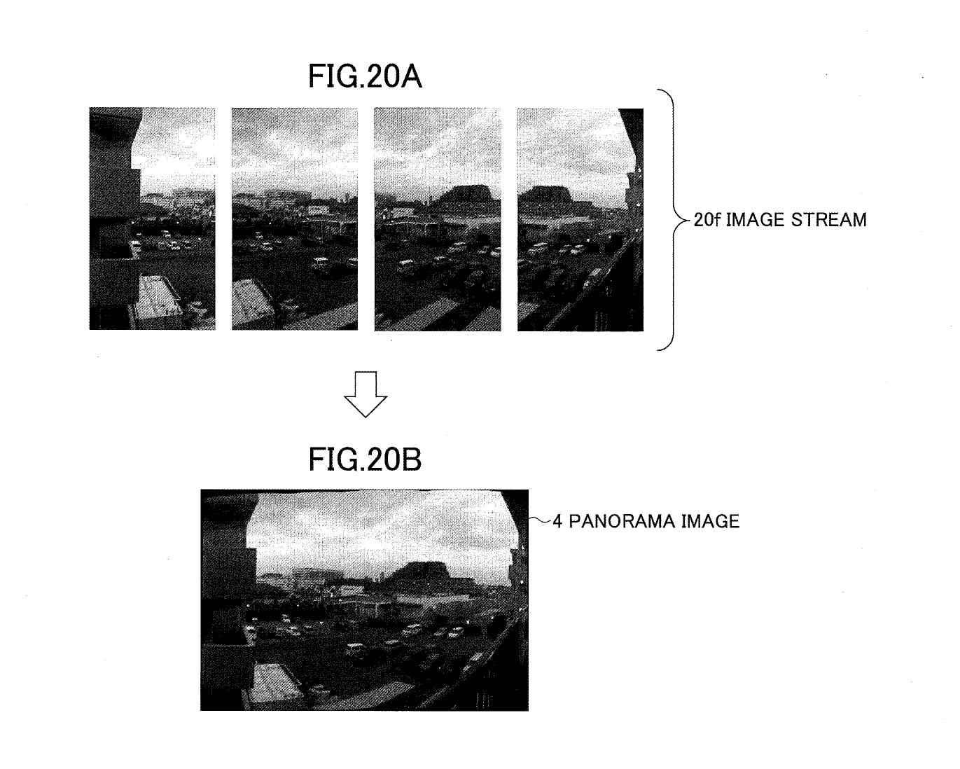

FIG. 20A and FIG. 20B are diagrams illustrating an example of the panorama image depending on the movement of right and left. In FIG. 20A, an example of an image stream 20f including successive multiple image frames is depicted. From the image stream 20f, the panorama image 4 is generated based on the same features, and displayed as illustrated in FIG. 20B.

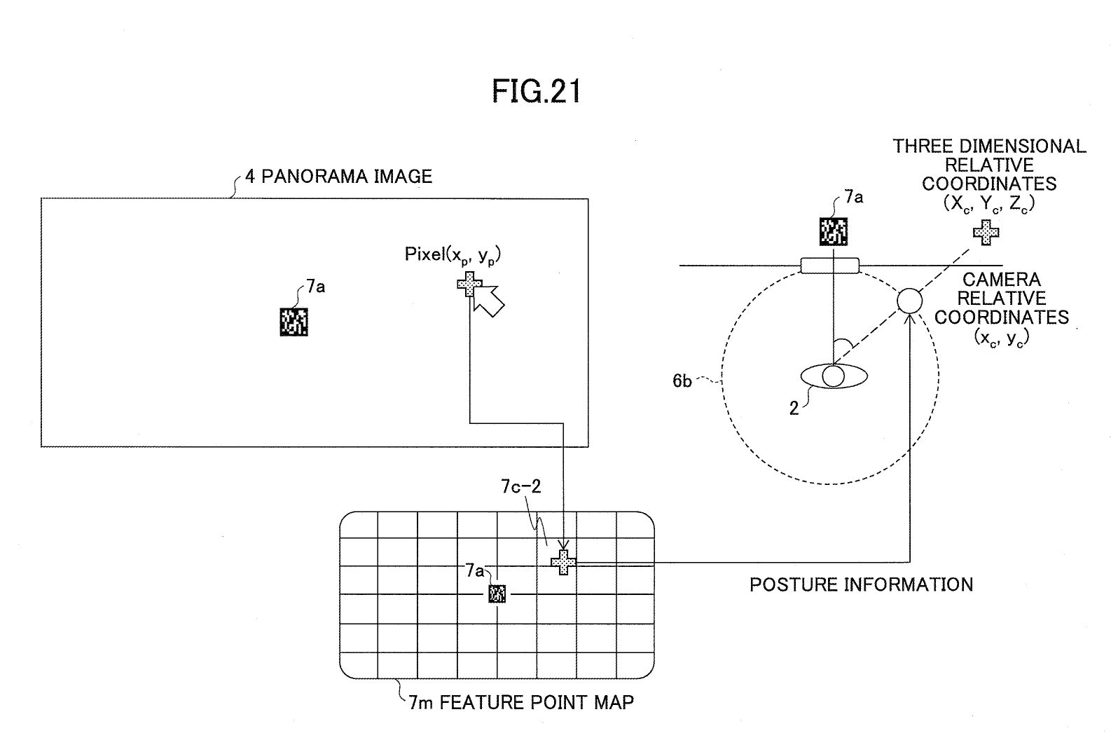

Next, a presentation method of the instruction from the remote support apparatus 101 will be described with reference to FIG. 21. FIG. 21 is a diagram for explaining the presentation method of the instructor. When the instruction is presented, in processes conducted by the support information creation part 146, an acquisition method of the instruction information 2f and the relative coordinates 2h, which are provided to the operator terminal 201, will be described. A case, in which the instructor 1 manipulates the input device 114 on the panorama image 4 displayed at the remote support apparatus 101 and indicates a location Pixel (x, y) as the operation target to the operator 2, will be described.

The instruction operation processing part 147 acquires a pixel location (xₚ, yₚ) where the instructor 1 points, at an event of pointing on a screen of the display device 115 by the instructor 1 using the input device 114, and reports the acquired pixel location (xₚ, yₚ) to the instruction information providing part 148. The pixel location (xₚ, yₚ) indicates the relative location with respect to the marker 7a in the panorama image 4.

The instruction information providing part 148 acquires the posture information from the cell 7c-2 corresponding to the pixel location (xₚ, yₚ) by referring to the feature point map 7m, and converts the location into a camera relative coordinates (x_{c}, y_{c}) based on the acquired posture information. A camera coordinate system 6r presents the relative coordinates with respect to the marker 7a at the side surface of the cylinder 6b in which the operator 2 locates at a center and a distance from the operator 2 to the marker 7a is regarded as a radius. The camera relative coordinates (x_{c}, y_{c}) acquired by the conversion correspond to a three dimensional relative coordinates (X_{c}, Y_{c}, Z_{c}) with respect to the marker 7a.

The instruction information providing part 148 sets the acquired camera relative coordinates (x_{c}, y_{c}) as the relative coordinates 2h into the instruction information 2f. Also, the instruction detail 2g, which the instructor 1 inputs to the remote support apparatus 101 for the operator 2, is set in the instruction information 2f, and is transmitted to the operator terminal 201.

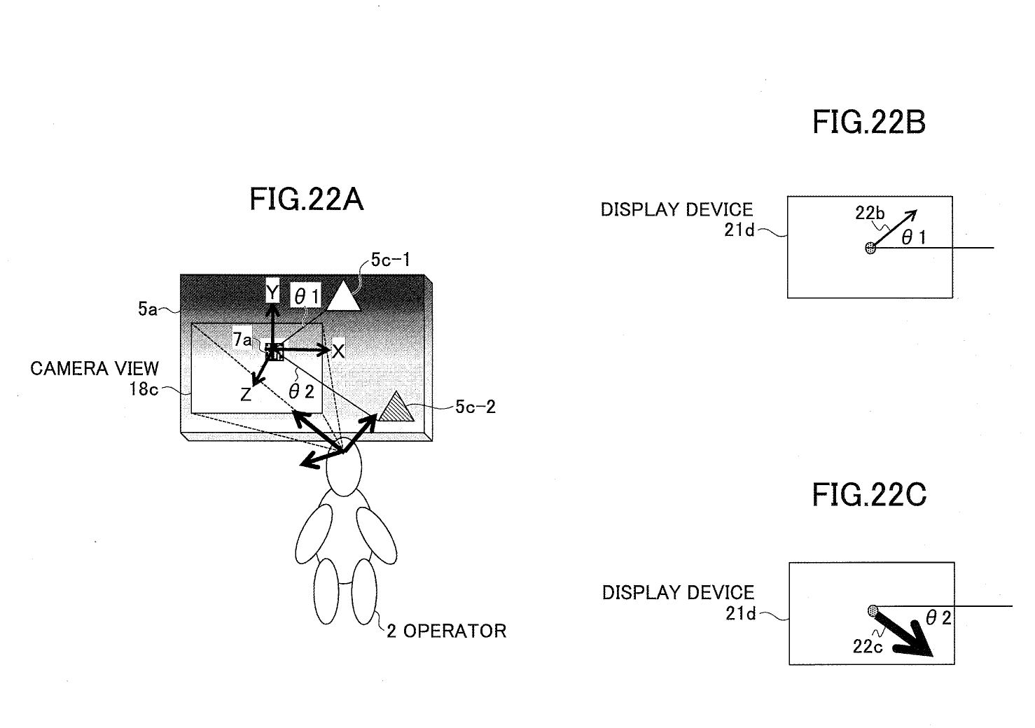

Next, a method for guiding the operator to an instruction target based on the reference point will be described with FIG. 22A, FIG. 22B, and FIG. 22C. FIG. 22A, FIG. 22B, and FIG. 22C are diagrams for explaining the method for guiding the operator 2 to the instruction target.

In FIG. 22A, it is assumed that the visual line of the operator 2 is currently in the camera view 18c. An instruction target 5c-1 is located at upper right at an angle θ1 with respect to a X-axis of the marker coordinate system, and an instruction target 5c-2 is located at lower right at the angle θ1 with respect to a Y-axis of the marker coordinate system.

In the operation support processing part 272 of the operator terminal 201, when the instruction information drawing part 276 of the support information display part 275 determines that the relative coordinates 2h of the instruction information 2f received through the network communication part 217 are located outside the current camera view 18c, the instruction information drawing part 276 reports the relative coordinates 2h to the off-screen part 277.

The off-screen part 277 calculates the distance from the marker 7a based on the relative coordinates 2h of the instruction target, and displays guide information depending on the distance. An example of guide information 22b to the instruction target 5c-1 in a case in which the distance is less than or equal to a threshold is depicted in FIG. 22B. An example of guide information 22c to the instruction target 5c-2 in which the distance is longer than the threshold is depicted in FIG. 22C.

It is preferable that the guide information 22b and the guide information 22c represent directions and movement amounts toward the instruction targets 5c-1 and 5c-2, respectively. The movement amount corresponds to the distance to the marker 7a.

In FIG. 22B, since the indication target 5c-1 is located at upper right at an angle θ1 with respect to the marker 7a, an arrow pointing to an upper right portion is displayed as the guide information 22b. Also, since a distance to the indication target 5c-1 is shorter than or equal to the threshold, the arrow as the guide information 22b is displayed shorter than the arrow as the guide information 22c in FIG. 22C.

In FIG. 22C, since the instruction target 5c-2 is located at lower right at an angle θ2, the arrow pointing a lower right portion is displayed as the guide information 22c. Also, since a distance to the instruction target 5c-2 is longer than the threshold, the arrow as the guide information 22c is displayed thicker than the arrow depicted in FIG. 22B.

The guide information 22b and the guide information 22c may change thickness of the arrow at real time in response to being closer or farther due to the movement of the operator 2. Also, depending on a movement direction of the operator 2, a direction of the arrow may be changed.

Also, the threshold may be provided for each of various distances, and respective thicknesses of the arrows may be defined for multiple thresholds. Instead of depending on various distances, the multiple thresholds may be determined depending on a ratio of the distance of the relative coordinates 2h of the marker 7a to a distance from the operator 2 to the marker 7a.

In the first embodiment, the arrow represents the direction, and the thickness of the arrow represents the movement amount as the guide information 22b and the guide information 22c. Instead, the movement amount may be represented by blinking frequency. The farther to a target, the more the blinking frequency is. The closer to the target, the less the blinking frequency is. Also, the guide information 22b and the guide information 22c may be represented in a manner in which voice or a specific sound may represent the distance and the movement amount.

In FIG. 22B and FIG. 22C, the guide information 22b and the guide information 22c are displayed at a center of the display device 21d. Instead, the guide information 22b and the guide information 22c may be displayed by shifting in the respective directions of the indication targets 5c-1 and 5c-2. In this case, the operator 2 tends to move the visual line to assure the guide information 22b and the guide information 22c. Naturally, the posture of the operator 2 is guided.

In FIG. 22B, the guide information 22b may be displayed at upper right from the center of the display device 21d to move the visual line of the operator 2 toward the upper right. Accordingly, the operator 2 attempts to chase the guide information 22b by moving the head toward the upper right, so that the operator 2 is led to the indication target 5c-1.

In FIG. 22C, in the same manner, the guide information 22c may be displayed at the lower right from the center of the display device 21d to move the visual line of the operator 2 toward the upper right. Accordingly, the operator 2 attempts to chase the guide information 22c by moving the head toward the lower right, so that the operator 2 is led to the indication target 5c-2.

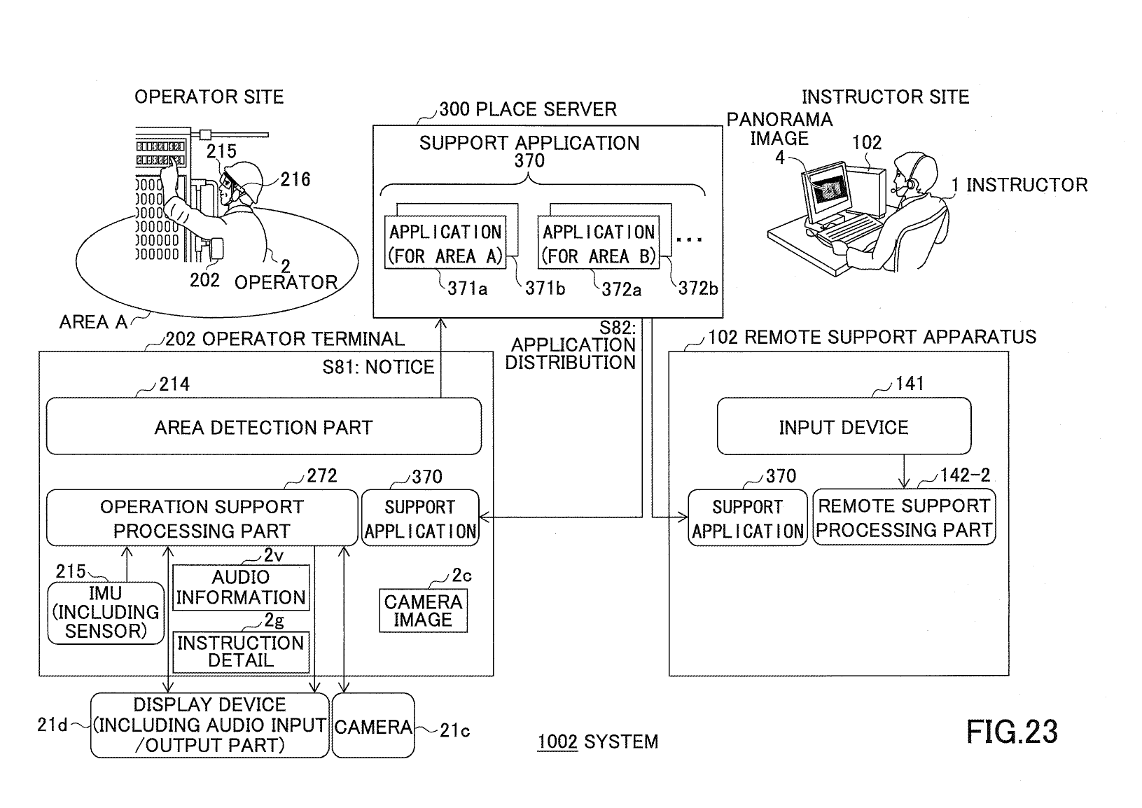

Next, a second embodiment will be described. In the second embodiment, under a condition in which the operator 2 enters an area to work, the operation support starts for the operator 2. FIG. 23 is a diagram illustrating a functional configuration in the second embodiment. A system 1002 depicted in FIG. 23 includes the functional configuration in which the operation support starts for the operator 2 under the condition in which the operator 2 enters the area to work.

In FIG. 23, the system 1002 includes the remote support apparatus 102, an operator terminal 202, and a place server 300. Hardware configurations of the remote support apparatus 102 and the operator terminal 202 are similar to the hardware configurations depicted in FIG. 4 in the first embodiment, and the explanations thereof will be omitted. The place server 300 is a computer that includes a CPU, a main storage device, a HDD, a network communication part, and the like.

In the system 1002, by cooperating with the place server 300, a support application 370 for the operator 2 (such as an application 371a, 372a, or the like) is provided to the operator terminal 202 of the operator 2, and the support application 370 for the instructor 1 (such as an application 371b, 372b, or the like) is provided to the remote support apparatus 102.

The place server 300 includes at least one support application 370, and provides the support application 370 corresponding to the area in response to a report indicating that the operator 2 enters the area.

The support application 370 is regarded as an application that navigates the operation in accordance with a work procedure scheduled in advance for each of areas.

In FIG. 23, an application 371 for an area A is applied for the area A, and an application 372 for an area B is applied for the area B. Each of the application 371 for the area A, the application 372 for the area B, and the like may be generally called “support application 370”.

The remote support apparatus 102 in the system 1002 includes the remote support processing part 142 similar to the system 1001, and at least one support application 370 provided from the place server 300.

In the system 1002, the operator terminal 202 includes an area detection part 214, the operation support processing part 272 similar to the system 1001, and the support application 370 provided from the place server 300.

In the system 1002, when the operator 2 possessing the operator terminal 202 enters the area A to work (a check-in state), the area detection part 214 detects that a location of the operator 2 is in the area A, and reports an area detection to the place server 300 through the network communication 217 (step S81).

When receiving a notice of the area detection from the operator terminal 202, the place server 300 selects the support application 370 corresponding to the area A indicated by the notice of the area detection, and distributes the support application 370 to the operator terminal 202 (step S82). That is, the application 371a for the area A is sent to the operator terminal 202.

The operator terminal 202 downloads the application 371a from the place server 300. The downloaded application 371a is stored in the memory 212 as the support application 370, and the operation support process starts when the application 371a is executed by the CPU 211 of the operator terminal 202.

By navigation of the operation procedure performed by the support application 370 (the application 371a in this case) and displaying the instruction information 2f from the instructor 1 by the operation support processing part 272, it is possible for the operator 2 to precisely conduct the operation.

Also, the place server 300 provides the application 371b for the area A to the remote support apparatus 102 in response to the notice of the area detection (step S82).

The remote support apparatus 102 downloads the application 371b for the area A from the place server 300. The downloaded application 371b is stored as the support application 370 in the memory 112 or the HDD 113, and the navigation of the operation procedure starts when the application 371b is executed by the remote support apparatus 102.

In the system 1002, it is possible for the operator 2 to receive the navigation of the operation procedure and support from the instructor 1.

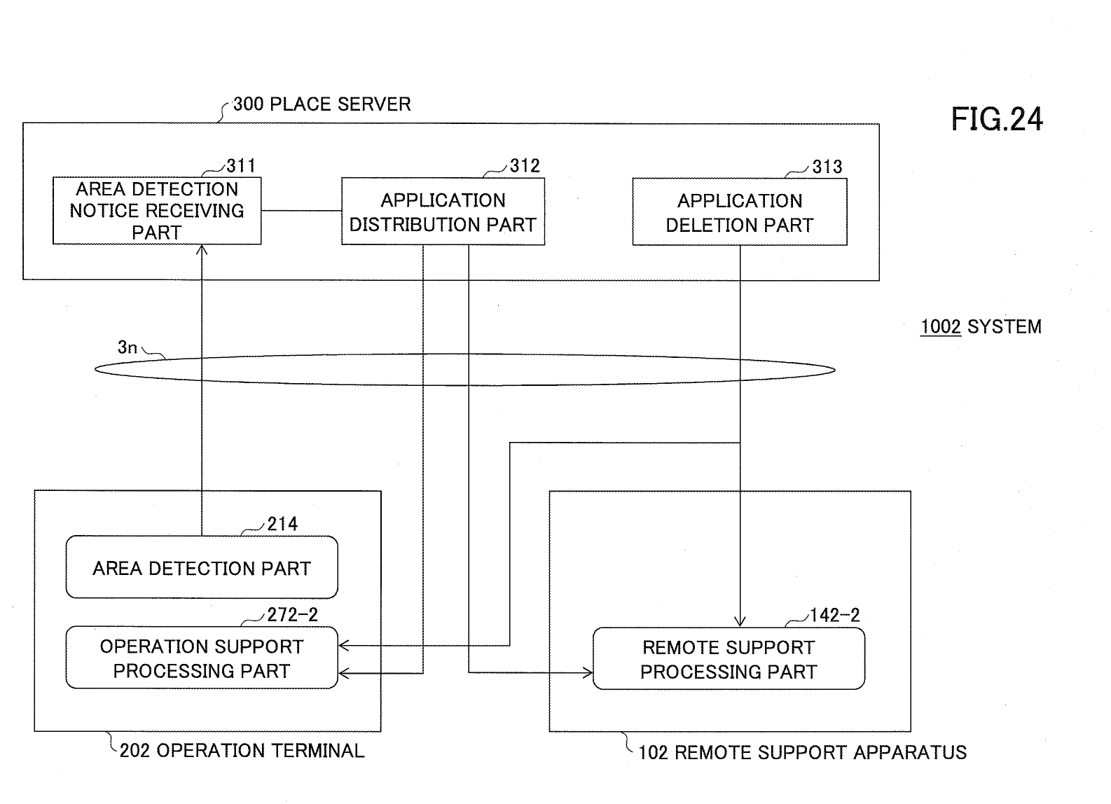

FIG. 24 is a diagram illustrating a functional configuration of the place server. In FIG. 24, the place server 300 of the system 1002 includes an area detection notice receiving part 311, an application distribution part 312, and an application deletion part 313.

The area detection notice receiving part 311 receives the notice of the area detection from the operator terminal 202 through a network 3n, and reports the area detection to the application distribution part 312.

The application distribution part 312 distributes the support application 370 corresponding to an area indicated by the area detection to the remote support apparatus 102 and the operator terminal 202. At the remote support apparatus 102 and the operator terminal 202, the same operation procedure is navigated in response to an operation start. Hence, it is possible to synchronize the operation procedure between the instructor 1 and the operator 2.

The application deletion part 313 deletes the distributed support application 370 from the remote support apparatus 102 and the operator terminal 202 in response to confirmation of an end of the operation.

As described above, the support application 370 is switched depending on the area where the operator works. By the navigation of the operation procedure and explanations by the instruction information 2f and voice of the instructor 1, it becomes easy for the operator 2 to complete the operation by himself or herself at the work site.

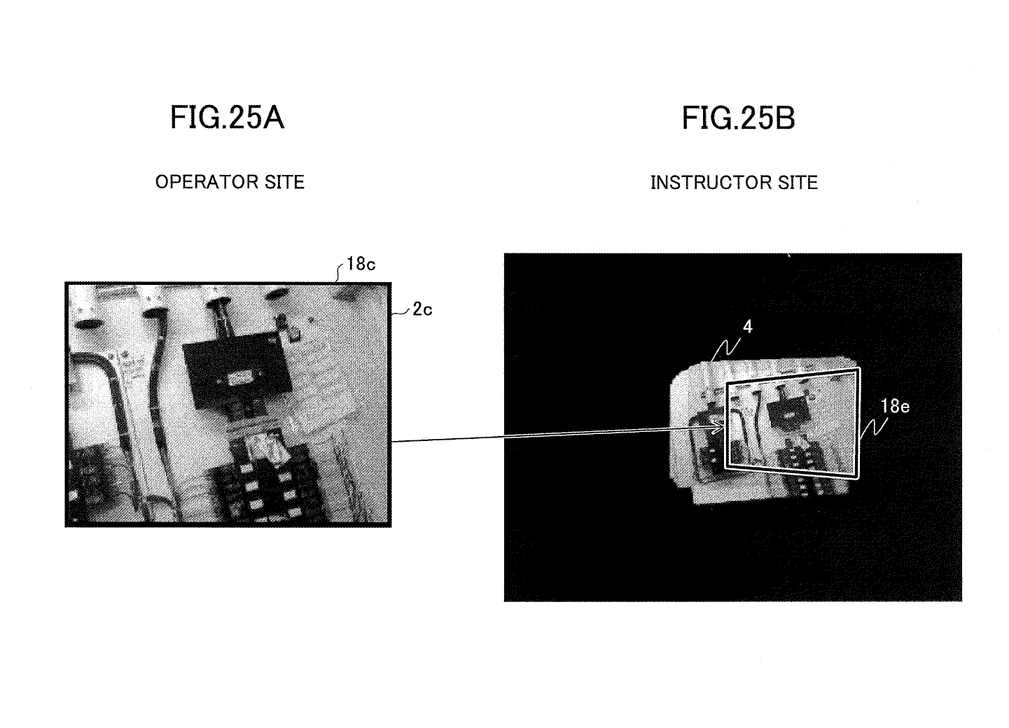

FIG. 25A and FIG. 25B are diagrams illustrating the panorama image in the first and second embodiments. In FIG. 25A and FIG. 25B, image examples at a time T1 shortly after the generation of the panorama image 4 starts are illustrated. FIG. 25A depicts an example of the latest camera image 2c at the time T1 after the camera 21c mounted on the head of the operator 2 begins capturing images. The camera view 18c corresponds to a region of the latest camera image 2c and is rectangular.

At the instructor site, as depicted in FIG. 25B, the panorama image 4, in which the latest and previous camera images 2c are composed, is displayed. The latest camera image 18e is outlined and displayed in the panorama image 4.

The panorama image 4 is formed by overlaying on the previous camera images 2c in a stream of the camera images 2c. Hence, an image range of the panorama image 4 may be flexibly extended in any direction. Accordingly, in the first and second embodiments, the image range of the panorama image 4 is not limited to a horizontal expansion alone.

The latest camera image 18e in the panorama image 4 is displayed by the coordinate conversion based on the integrated posture information 2e and the like. Hence, the panorama image 4 is not always displayed in the shape of a rectangle. As illustrated in FIG. 25B, the latest camera image 18e is outlined in a shape such as a trapezoid or the like. After that, by a new camera image 2c, the panorama image 4 is further updated.

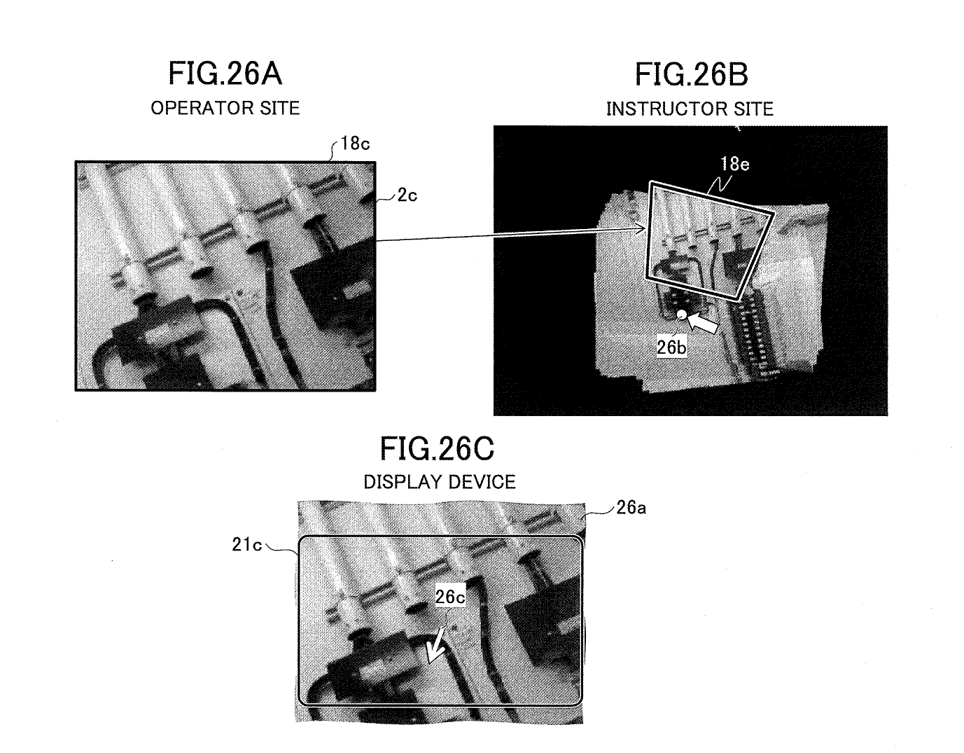

FIG. 26A, FIG. 26B, and FIG. 26C are diagrams illustrating image examples at a time T2 after the time T1. FIG. 26A illustrates an example of the latest camera image 2c at the time T2 after the time T1. The camera view 18c corresponds to the region of the latest camera image 2c, and is the same size of the rectangular image depicted in FIG. 25A

At the operator site, as depicted in FIG. 26B, a latest panorama image 4 is displayed in which multiple recent camera images 2c acquired after the time T1 are overlaid with the panorama image 4 illustrated in FIG. 25B after the coordinate conversion. The latest camera image 18e is outlined and displayed in the panorama image 4.

In this case, the latest camera image 18e is outlined in the trapezoid. The panorama image 4 is being updated at real time. In this example, an image area becomes larger than the image area of the panorama image 4 depicted in FIG. 25B.

In the panorama image 4 in FIG. 26B, when the instructor 1 points a location outside the latest camera image 18e, guide information 26c representing the direction and the movement amount is displayed at the display device 21c of the operator 2 at real time as illustrated in FIG. 26C.

In FIG. 26C, a view is illustrated in the visual line direction of the operator 2 on whom is mounted the display device 21c. By displaying the guide information 26c at the display device 21c, it is possible for the operator 2 to see the guide information 26c overlapped in the real view.

Since the guide information 26c points toward lower left, the operator 2 moves a body to incline the posture to the lower left.

As described above, in the first and second embodiments, it is possible to generate, at higher speed, the panorama image 4 from the multiple camera images 2c captured by a dynamically moving device.

Also, even if the instruction target is located outside the latest camera image 18e, it is possible for the instructor 1 to point to the instruction target in the panorama image 4 including the previous camera images 2c. Since the guide information 26c is overlapped and is seen in the real view, the operator 2 does not need to consciously match the guide information 26c displayed at the display device 21c with the real view.

According to the first embodiment and the second embodiment, it is possible to generate the panorama image 4 by using a mobile apparatus at higher speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image generation method comprising:
capturing a first image including an object placed in a real space by using an imaging device;
detecting a first posture of the imaging device when the first image is captured;
capturing, by the imaging device, a second image including the object placed in the real space;
detecting, by a computer, a second posture of the imaging device when the second image is captured;
calculating, by the computer, a relative location relationship between a first object location included in the first image and a second object location included in the second image based on the first posture and the second posture; and
generating, by the computer, a third image by merging the first image and the second image based on the calculated relative location relationship.

2. The image generation method as claimed in claim 1, further comprising:
estimating, by the computer, a first search area including the object in the first image and a second search area including the object in the second image; and
calculating, by the computer, the relative location relationship between the first object location included in the first search area and the second object location included in the second search area.

3. The image generation method as claimed in claim 1, further comprising:
deforming, by the computer, the first image based on the detected first posture; and
generating, by the computer, the third image by deforming the second image based on the detected second posture and merging the first image and the second image based on the relative location relationship.

4. The image generation method as claimed in claim 1, wherein at least one of the first posture and the second posture is indicated by integrated posture information, which is acquired by integrating estimated posture information acquired by estimating a location and a posture of the imaging device in a three dimension space and sensor posture information acquired by an inertial sensor.

5. A system for conducting a remote support, comprising:
a terminal; and
an apparatus connected to the terminal through a network,
wherein the terminal performs, by a terminal computer, a terminal process including
inputting, from an imaging device, multiple images including an object placed in a real space, the multiple images being captured by the image device;
receiving, from the apparatus, support information by sending each of the multiple images and posture information indicating a posture when an image is captured, to the apparatus through a network communication part; and
displaying the support information at a display device,
wherein the apparatus performs, by an apparatus computer, a remote support process including
calculating a relative location relationship between a first object location included in the first image and a second object location included in the second image based on a first posture information of the first image and a second posture information of the second image, the first posture information and the second posture information being received from the terminal;
displaying, at a display device, a third image by merging the first image and the second image based on a calculated relative location relationship; and
sending the support information indicating coordinates of an instruction location pointed to by an input device in the third image.

6. The system as claimed in claim 5, wherein the remote support process further includes
estimating a first search area including the object in the first image and a second search area including the object in the second image; and
calculating the relative location relationship between the first object location included in the first search area and the second object location included in the second search area.

7. The system as claimed in claim 5, wherein the remote support process further includes
deforming the first image based on the first posture information;
deforming the second image based on the second posture information; and
generating the third image by merging the first image and the second image based on the relative location relationship.

8. The system as claimed in claim 5, wherein at least one of the first posture information and the second posture information is the posture information acquired by integrating estimated posture information and sensor posture information, the estimated posture information being acquired by estimating a location and a posture of the terminal in a three dimension space, the sensor posture information being acquired by an inertial sensor.

9. The system as claimed in claim 5,
wherein the coordinates of the instruction location are relative coordinates with respect to the reference point defined beforehand, and
wherein the remote support process further includes forming a display corresponding to a direction and a distance of the coordinates when the coordinates are positioned outside a camera view of the imaging device.

10. A remote support apparatus comprising:
a processor that executes a process including
calculating a relative location relationship between a first object location included in a first image and a second object location included in a second image based on first posture information of the first image and second posture information of the second image, the first posture information and the second posture information being received through a network communication part;
generating a third image by merging the first image and the second image based on a calculated relative location relationship, and displaying the third image at a display device; and
sending the support information including coordinates of an instruction location pointed to by an input device in the third image.

11. The remote support apparatus as claimed in claim 10, wherein the process further includes
estimating a first search area including the object in the first image and a second search area including the object in the second image; and
calculating the relative location relationship between the first object location included in the first search area and the second object location included in the second search area.

12. The remote support apparatus as claimed in claim 10, where the process further includes
deforming the first image based on the first posture information;
deforming the second image based on the second posture information; and
generating the third image by merging the first image and the second image based on the relative location relationship.
